(19) United States
(12) Patent Application Publication
(10) Pub. No.: US 2021/0151271 A1
(43) Pub. Date: May 20, 2021

(54) CONTACT DEVICE, AND ELECTROMAGNETIC RELAY

(71) Applicant: Panasonic Intellectual Property Management Co., Ltd., Osaka (JP)

(72) Inventors: Kazuhiro KODAMA, Hokkaido (JP); Shinya KIMOTO, Osaka (JP); Ryosuke OZAKI, Osaka (JP)

(73) Assignee: Panasonic Intellectual Property Management Co., Ltd., Osaka (JP)

(21) Appl. No.: 16/766,451

(22) PCT Filed: Nov. 21, 2018
(86) PCT No.: PCT/JP2018/043066

§ 371 Date: May 22, 2020

(30) Foreign Application Priority Data
Nov. 27, 2017 (JP) 2017-227280
Nov. 27, 2017 (JP) 2017-227281

(51) Int. Cl. H01H 50/42; H01H 50/14

(52) U.S. Cl. CPC H01H 50/42; H01H 2050/362; H01H 50/14

(57) ABSTRACT

A contact device includes a fixed terminal, a moving contactor, a moving yoke, and a bus bar. The moving contactor moves from a closed position where a moving contact is in contact with a fixed contact to an open position where the moving contact is out of contact with the fixed contact, and vice versa. The moving yoke moves, as the moving contactor moves, in a direction of movement of the moving contactor. The bus bar generates, when energized, a magnetic field having a direction aligned with the direction of movement of the moving contactor. The bus bar is arranged, with respect to the moving yoke when the moving contactor is currently located at the closed position, in a direction in which the moving contactor moves from the open position toward the closed position.

### TECHNICAL FIELD

The present disclosure generally relates to a contact device and an electromagnetic relay, and more particularly relates to a contact device and electromagnetic relay which are configured to selectively bring a moving contact into contact, or out of contact, with a fixed contact.

### BACKGROUND ART

Patent Literature 1 discloses a contact device for selectively passing, or cutting off, an electric current through/at a contact.

Specifically, the contact device disclosed in Patent Literature 1 causes a moving contactor, included in the contact device, to be moved by electromagnetic force generated by energizing an excitation coil (excitation winding) of an electromagnet device, thereby bringing the moving contact of the moving contactor into contact with a fixed contact of a fixed terminal included in the contact device. This allows the moving contactor to be connected to the fixed terminal.

In the contact device described above, when an abnormal electric current such as a short-circuit current flows, for example, Lorenz force (i.e., electromagnetic repulsion) is applied to the moving contactor in such a direction as to bring the moving contact out of contact with the fixed contact, thus possibly decreasing the stability of connection between the moving contact and the fixed contact.

### CITATION LIST

### Patent Literature

Patent Literature 1: JP 2014-232668 A

### SUMMARY OF INVENTION

In view of the foregoing background, it is therefore an object of the present disclosure to provide a contact device and electromagnetic relay, both of which are configured to increase the stability of connection between the moving contact and the fixed contact.

A contact device according to an aspect of the present disclosure includes a fixed terminal, a moving contactor, a moving yoke, and a bus bar. The fixed terminal has a fixed contact. The moving contactor has a moving contact and moves from a closed position where the moving contact is in contact with the fixed contact to an open position where the moving contact is out of contact with the fixed contact, and vice versa. The moving yoke moves, as the moving contactor moves, in a direction of movement of the moving contactor. The bus bar generates, when energized, a magnetic field having a direction aligned with the direction of movement of the moving contactor. The bus bar is arranged, with respect to the moving yoke when the moving contactor is currently located at the closed position, in a direction in which the moving contactor moves from the open position toward the closed position.

A contact device according to another aspect of the present disclosure includes a fixed terminal, a moving contactor, a moving yoke, a fixed yoke, and a bus bar. The fixed terminal has a fixed contact. The moving contactor has a moving contact and moves from a closed position where the moving contact is in contact with the fixed contact to an open position where the moving contact is out of contact with the fixed contact, and vice versa. The moving moves, as the moving contactor moves, in a direction of movement of the moving contactor. The fixed yoke is arranged on the same side as the fixed contact with respect to the moving yoke so as to face the moving yoke in the direction of movement of the moving contactor. The fixed yoke has a relative position thereof fixed with respect to the fixed terminal when the moving contactor is currently located at the closed position. The bus bar generates, when energized, a magnetic field that magnetizes the moving yoke and the fixed yoke such that respective poles, facing each other, of the moving yoke and the fixed yoke have mutually opposite polarities.

An electromagnetic relay according to still another aspect of the present disclosure includes the contact device described above and an electromagnet device to move the moving contactor.

### BRIEF DESCRIPTION OF DRAWINGS

FIG. 1A is a perspective view of an electromagnetic relay according to a first embodiment;

FIG. 1B is a cross-sectional view of the electromagnetic relay taken along the plane X1-X1;

FIG. 2 is a cross-sectional view of the electromagnetic relay taken along the plane X2-X2;

FIG. 3 illustrates the flow of an electric current in a contact device included in the electromagnetic relay;

FIG. 4 illustrates relative positions of a moving contactor and a moving yoke included in the contact device;

FIG. 5 illustrates how to stretch the arc generated in the contact device;

FIG. 6 illustrates the position of a moving yoke according to a variation of the first embodiment;

FIG. 7 illustrates the flow of an electric current in a contact device according to a variation of the first embodiment;

FIG. 8A is a perspective view of an electromagnetic relay according to a second embodiment;

FIG. 8B is a cross-sectional view of the electromagnetic relay taken along the plane X1-X1;

FIG. 9 is a cross-sectional view of the electromagnetic relay taken along the plane X2-X2;

FIG. 10 illustrates the flow of an electric current in a contact device included in the electromagnetic relay;

FIG. 11 illustrates relative positions of a fixed yoke, a moving contactor and a moving yoke included in the contact device;

FIG. 12 illustrates the position of a fixed yoke according to a first variation of the second embodiment;

FIG. 13A is a perspective view of an electromagnetic relay according to a second variation of the second embodiment;

FIG. 13B is a cross-sectional view of the electromagnetic relay taken along the plane X3-X3;

FIG. 14 illustrates positions of a fixed yoke and a moving yoke according to a third variation of the second embodiment;

FIG. 15A is a perspective view of an electromagnetic relay according to a fourth variation of the second embodiment;

FIG. 15B is a cross-sectional view of the electromagnetic relay taken along the plane X4-X4; and

FIG. 16 illustrates the flow of an electric current in a contact device according to a fifth variation of the second embodiment.

### DESCRIPTION OF EMBODIMENTS

Note that embodiments and their variations to be described below are only examples of the present disclosure and should not be construed as limiting. Rather, those embodiments and variations may be readily modified in various manners depending on a design choice or any other factor without departing from a true spirit and scope of the present disclosure. It should also be noted that the drawings to be referred to in the following description of embodiments and their variations are all schematic representations. That is to say, the ratio of the dimensions (including thicknesses) of respective constituent elements illustrated on the drawings does not always reflect their actual dimensional ratio.

### First Embodiment

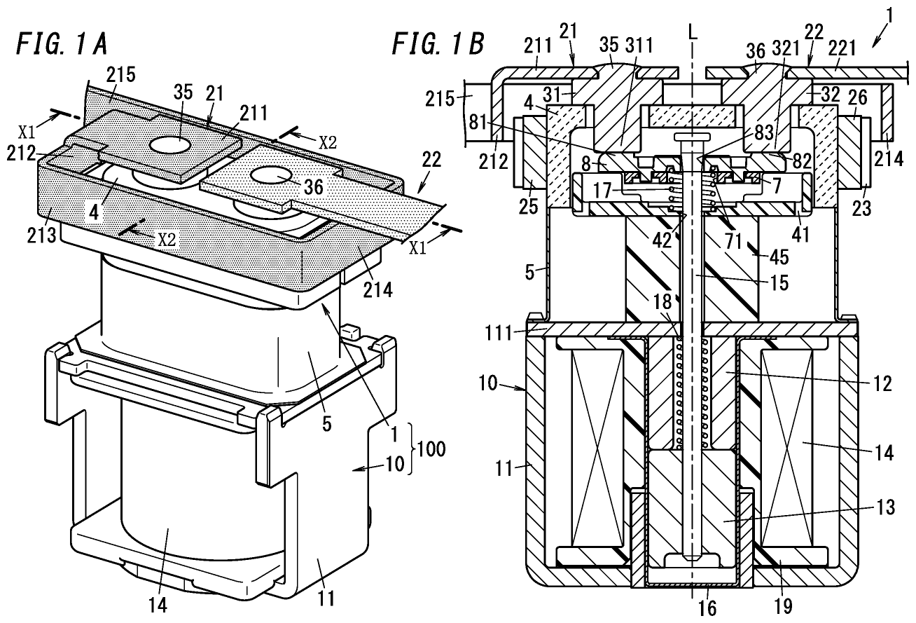

A contact device 1 and electromagnetic relay 100 according to a first exemplary embodiment will be described with reference to FIGS. 1A-5.

(1) Configuration

(1.1) Overall Configuration

An electromagnetic relay 100 according to this embodiment includes a contact device 1 and an electromagnet device 10. The contact device 1 includes a pair of fixed terminals 31, 32 and a moving contactor 8 (see FIG. 1B). Each of the fixed terminals 31, 32 holds a fixed contact 311, 321 thereon. The moving contactor 8 holds a pair of moving contacts 81, 82 thereon.

The electromagnet device 10 includes a mover 13 and an excitation coil 14 (see FIG. 1B). The electromagnet device 10 is configured to have the mover 13 attracted by a magnetic field generated by the excitation coil 14 when the excitation coil 14 is energized. Attracting the mover 13 causes the moving contactor 8 to move from an open position to a closed position. As used herein, the “open position” refers to the position of the moving contactor 8 when the moving contacts 81, 82 go out of contact with the fixed contacts 311, 321, respectively. Also, as used herein, the “closed position” refers to the position of the moving contactor 8 when the moving contacts 81, 82 come into contact with the fixed contacts 311, 321, respectively.

Also, in this embodiment, the mover 13 is arranged along a line L and configured to reciprocate straight along the line L. The excitation coil 14 is configured as a conductive wire (electric wire) wound around the line L. That is to say, the line L corresponds to the center axis of the excitation coil 14.

In the embodiment to be described below, the contact device 1 is supposed to form, along with the electromagnet device 10, the electromagnetic relay 100 as shown in FIG. 1A. However, this is only an example and should not be construed as limiting. The contact device 1 does not have to be applied to the electromagnetic relay 100 but may also be used in a breaker (circuit breaker), a switch, or any other type of electrical equipment. Also, in the embodiment to be described below, the electromagnetic relay 100 is supposed to be used as a part of onboard equipment for an electric vehicle. In that case, the contact device 1 (fixed terminals 31, 32) is electrically connected on a path along which DC power is supplied from a traveling battery to a load (such as an inverter).

(1.2) Contact Device

Next, a configuration for the contact device 1 will be described.

As shown in FIGS. 1A and 1B, the contact device 1 includes the pair of fixed terminals 31, 32, the moving contactor 8, a housing 4, a flange 5, and two bus bars 21, 22. The contact device 1 further includes a moving yoke 7, two capsule yokes 23, 24, two arc extinction magnets (permanent magnets) 25, 26, an insulation plate 41, and a spacer 45. The fixed terminal 31 holds the fixed contact 311 thereon, and the fixed terminal 32 holds the fixed contact 321 thereon. The moving contactor 8 is a plate member made of a metallic material with electrical conductivity. The moving contactor 8 holds a pair of moving contacts 81, 82, which are arranged to face the pair of fixed contacts 311, 321, respectively.

In the following description, the direction in which the fixed contacts 311, 321 and the moving contacts 81, 82 face each other is defined herein to be an upward/downward direction, and the fixed contacts 311, 321 are located on an upper side when viewed from the moving contacts 81, 82, just for the sake of convenience. In addition, the direction in which the pair of fixed terminals 31, 32 (i.e., the pair of fixed contact 311, 321) are arranged side by side is defined herein to be a rightward/leftward direction, and the fixed terminal 32 is supposed to be located on the right when viewed from the fixed terminal 31. That is to say, in the following description, the upward, downward, rightward, and leftward directions are supposed to be defined on the basis of the directions shown in FIG. 1B. Furthermore, in the following description, the direction perpendicular to both the upward/downward direction and the rightward/leftward direction (i.e., the direction coming out of the paper on which FIG. 1B is depicted) is defined herein to be a forward/backward direction. Note that these directions should not be construed as limiting a mode of using the contact device 1 or the electromagnetic relay 100.

One (first) fixed contact 311 is held at the bottom (one end) of one (first) fixed terminal 31, while the other (second) fixed contact 321 is held at the bottom (one end) of the other (second) fixed terminal 32.

The pair of fixed terminals 31, 32 are arranged side by side in the rightward/leftward direction (see FIG. 1B). Each of the pair of fixed terminals 31, 32 is made of an electrically conductive metallic material. The pair of fixed terminals 31, 32 serves as terminals for connecting an external circuit (including a battery and a load) to the pair of fixed contacts 311, 321. In this embodiment, the fixed terminals 31, 32 are supposed to be made of copper (Cu), for example. However, this is only an example and should not be construed as limiting. Alternatively, the fixed terminals 31, 32 may also be made of any electrically conductive material other than copper.

Each of the pair of fixed terminals 31, 32 is formed in the shape of a cylinder, of which a cross section, taken along a plane intersecting with the upward/downward direction at right angles, is circular. In this embodiment, each of the pair of fixed terminals 31, 32 is formed in a T-shape in a front view such that its diameter at the upper end (at the other end) is larger than its diameter at the lower end (at the one end). The pair of fixed terminals 31, 32 are each held by the housing 4 such that part of the fixed terminal 31, 32 protrudes (at the other end) from the upper surface of the housing 4. Specifically, each of the pair of fixed terminals 31, 32 is fixed onto the housing 4 so as to run through an opening cut through the upper wall of the housing 4.

The moving contactor 8 is formed in the shape of a plate having thickness in the upward/downward direction and having a greater dimension in the rightward/leftward direction than in the forward/backward direction. The moving contactor 8 is arranged under the pair of fixed terminals 31, 32 such that both longitudinal ends thereof (i.e., both ends thereof in the rightward/leftward direction) face the pair of fixed contacts 311, 321, respectively (see FIG. 1B). Portions, respectively facing the pair of fixed contacts 311, 321, of the moving contactor 8 are provided with the pair of moving contacts 81, 82, respectively (see FIG. 1B).

The moving contactor 8 is housed in the housing 4. The moving contactor 8 is moved up and down (i.e., in the upward/downward direction) by the electromagnet device 10 arranged under the housing 4, thus allowing the moving contactor 8 to move from the closed position to the open position, and vice versa. FIG. 1B illustrates a state where the moving contactor 8 is currently located at the closed position. In this state, the pair of moving contacts 81, 82 held by the moving contactor 8 are in contact with their associated fixed contacts 311, 321, respectively. On the other hand, in a state where the moving contactor 8 is currently located at the open position, the pair of moving contacts 81, 82 held by the moving contactor 8 are out of contact with their associated fixed contacts 311, 321, respectively.

Therefore, when the moving contactor 8 is currently located at the closed position, the pair of fixed terminals 31, 32 are short-circuited together via the moving contactor 8. That is to say, when the moving contactor 8 is currently located at the closed position, the moving contacts 81, 82 come into contact with the fixed contacts 311, 321, respectively, and therefore, the fixed terminal 31 is electrically connected to the fixed terminal 32 via the fixed contact 311, the moving contact 81, the moving contactor 8, the moving contact 82, and the fixed contact 321. Thus, if the fixed terminal 31 is electrically connected to one member selected from the group consisting of the battery and the load and the fixed terminal 32 is electrically connected to the other member, the contact device 1 forms a path along which DC power is supplied from the battery to the load while the moving contactor 8 is located at the closed position.

In this embodiment, the moving contacts 81, 82 only need to be held by the moving contactor 8. Therefore, the moving contacts 81, 82 may be formed by hammering out portions of the moving contactor 8, for example, so as to form integral parts of the moving contactor 8. Alternatively, the moving contacts 81, 82 may be members provided separately from the moving contactor 8 and may be secured, by welding, for example, onto the moving contactor 8. Likewise, the fixed contacts 311, 321 only need to be held by the fixed terminals 31, 32, respectively. Therefore, the fixed contacts 311, 321 may form integral parts of the fixed terminals 31, 32, respectively. Alternatively, the fixed contacts 311, 321 may be members provided separately from the fixed terminals 31, 32 and may be secured, by welding, for example, onto the fixed terminals 31, 32, respectively.

The moving contactor 8 has a through hole 83 at a middle portion thereof. In this embodiment, the through hole 83 is provided at a halfway point between the pair of moving contacts 81, 82 of the moving contactor 8. The through hole 83 runs through the moving contactor 8 along the thickness thereof (i.e., in the upward/downward direction). The through hole 83 is provided to pass a shaft 15 (to be described later) therethrough.

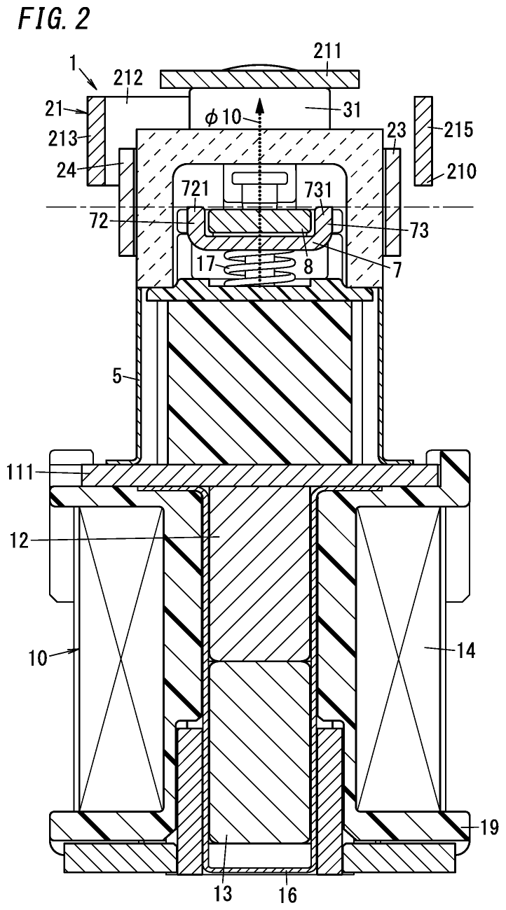

The moving yoke 7 is a ferromagnetic body and may be made of a metallic material such as iron. As the moving contactor 8 moves, the moving yoke 7 also moves in the direction of movement of the moving contactor 8 (i.e., in the upward/downward direction). The moving yoke 7 is fixed on the lower surface of the moving contactor 8 (see FIG. 1B). Thus, as the moving contactor 8 moves up and down (in the upward/downward direction), the moving yoke 7 also moves up and down (in the upward/downward direction). Optionally, an insulating layer 90 with electrical insulation properties may be provided on the upper surface (particularly, a portion to come in contact with the moving contactor 8) of the moving yoke 7 (see FIG. 4). This ensures electrical insulation between the moving contactor 8 and the moving yoke 7. Note that in FIGS. 1B, 2, and other drawings, illustration of the insulating layer 90 is omitted as appropriate.

The moving yoke 7 also has a through hole 71 at a middle portion thereof. In this embodiment, the through hole 71 is aligned with the through hole 83 of the moving contactor 8. The through hole 71 runs through the moving yoke 7 along the thickness thereof (i.e., in the upward/downward direction). The through hole 71 is provided to pass the shaft 15 and a contact pressure spring 17 (to be described later) therethrough.

The moving yoke 7 has, at both ends in the forward/backward direction, a pair of protrusions 72, 73 protruding upward (see FIG. 2). In other words, at both ends in the forward/backward direction of the upper surface of the moving yoke 7, provided are protrusions 72, 73 protruding in the direction of movement of the moving contactor 8 from the open position toward the closed position (i.e., upward in this embodiment). That is to say, at least part of the moving yoke 7 is located opposite from the fixed contacts 311, 321 with respect to the moving contactor 8 in the direction of movement of the moving contactor 8.

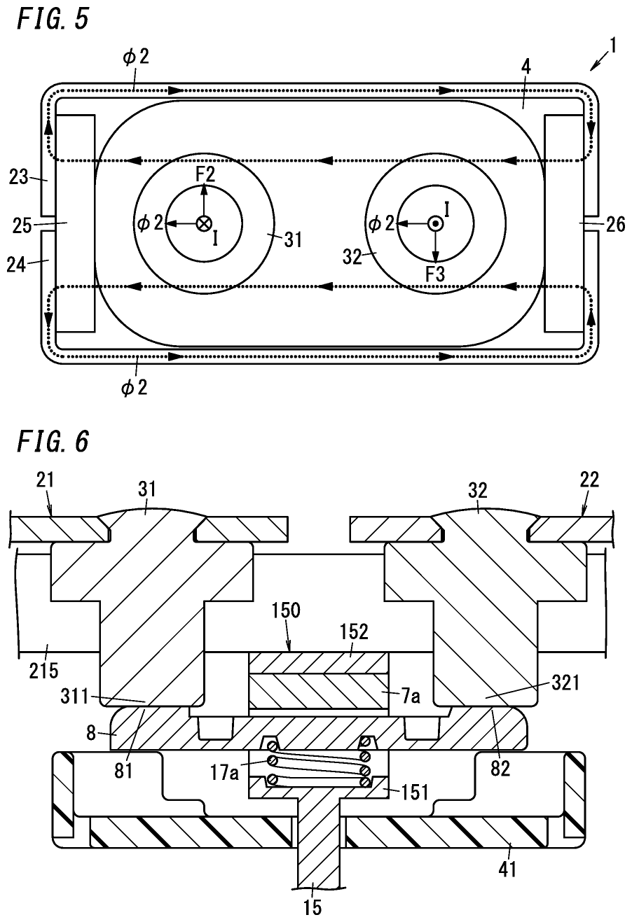

The capsule yokes 23, 24 are configured as ferromagnetic bodies and may be made of a metallic material such as iron. The capsule yokes 23, 24 each hold arc extinction magnets 25, 26. The capsule yokes 23, 24 are arranged on both sides in the forward/backward direction with respect to the housing 4 (i.e., in front of and behind the housing 4) so as to surround the housing 4 on both sides in the forward/backward direction (see FIG. 5). In FIG. 5, illustration of the bus bars 21, 22 is omitted.

The arc extinction magnets 25, 26 are arranged such that their poles facing each other in the rightward/leftward direction have mutually opposite polarities. In other words, the arc extinction magnets 25, 26 are arranged as extensions in the direction in which an electric current I flows through the moving contactor 8. The arc extinction magnets 25, 26 are arranged at both ends in the rightward/leftward direction with respect to the housing 4. The arc extinction magnets 25, 26 stretch the arc generated between the moving contacts 81, 82 and the fixed contacts 311, 321 while the moving contactor 8 moves from the closed position toward the open position. The capsule yokes 23, 24 encapsulate the housing 4 as well as the arc extinction magnets 25, 26 in their entirety. In other words, the arc extinction magnets 25, 26 are interposed between the right and left end faces of the housing 4 and the capsule yokes 23, 24. Specifically, one surface in the rightward/leftward direction (i.e., left end face) of one (left) arc extinction magnet 25 is coupled to one end of the capsule yokes 23, 24 and the other surface in the rightward/leftward direction (i.e., right end face) of the arc extinction magnet 25 is coupled to the housing 4. One surface in the rightward/leftward direction (i.e., right end face) of the other (right) arc extinction magnet 26 is coupled to the other end of the capsule yokes 23, 24 and the other surface in the rightward/leftward direction (i.e., left end face) of the arc extinction magnet 26 is coupled to the housing 4. In this embodiment, the arc extinction magnets 25, 26 are arranged such that their poles facing each other in the rightward/leftward direction have mutually opposite polarities. However, this is only an example and should not be construed as limiting. Alternatively, the arc extinction magnet 25, 26 may also be arranged such that their poles facing each other in the rightward/leftward direction have the same polarity.

In this embodiment, while the moving contactor 8 is currently located at the closed position, the respective points of contact between the pair of fixed contacts 311, 321 and the pair of moving contacts 81, 82 are located between the arc extinction magnets 25, 26 (see FIG. 1B). That is to say, the respective points of contact between the pair of fixed contacts 311, 321 and the pair of moving contacts 81, 82 fall within a magnetic field generated between the arc extinction magnets 25, 26.

According to this configuration, the capsule yoke 23 forms part of a magnetic circuit, through which a magnetic flux φ2 generated by the pair of arc extinction magnets 25, 26 passes, as shown in FIG. 5. Likewise, the capsule yoke 24 also forms part of a magnetic circuit, through which a magnetic flux φ2 generated by the pair of arc extinction magnets 25, 26 passes, as shown in FIG. 5. These magnetic fluxes φ2 have magnetic effect on the points of contact between the pair of fixed contacts 311, 321 and the pair of moving contacts 81, 82 in a state where the moving contactor 8 is currently located at the closed position.

In the example illustrated in FIG. 5, in the internal space of the housing 4, leftward magnetic fluxes φ2 are supposed to have been generated, a downward electric current I is supposed to flow through the fixed terminal 31, and an upward electric current I is supposed to flow through the fixed terminal 32. When the moving contactor 8 moves from the closed position toward the open position in such a state, an electric discharge current (arc) is generated downward from the fixed contact 311 toward the moving contact 81 between the fixed contact 311 and the moving contact 81. Thus, the magnetic flux φ2 applies backward Lorenz force F2 to the arc (see FIG. 5). As a result, the arc generated between the fixed contact 311 and the moving contact 81 is stretched backward to be extinct. On the other hand, an electric discharge current (arc) is generated upward from the moving contact 82 toward the fixed contact 321 between the fixed contact 321 and the moving contact 82. Thus, the magnetic flux φ2 applies forward Lorenz force F3 to the arc (see FIG. 5). As a result, the arc generated between the fixed contact 321 and the moving contact 82 is stretched forward to be extinct.

The housing 4 may be made of a ceramic material such as aluminum oxide (alumina). The housing 4 is formed in the shape of a hollow rectangular parallelepiped, of which the dimension is greater in the rightward/leftward direction than in the forward/backward direction (see FIG. 1B). The lower surface of the housing 4 is open. The housing 4 houses the pair of fixed contacts 311, 321, the moving contactor 8, and the moving yoke 7. The upper surface of the housing 4 has a pair of openings to pass the pair of fixed terminals 31, 32 therethrough. The pair of openings may be formed in a circular shape, for example, and runs through the upper wall of the housing 4 along the thickness thereof (i.e., in the upward/downward direction). The fixed terminal 31 is passed through one opening and the fixed terminal 32 is passed through the other opening. The pair of fixed terminals 31, 32 and the housing 4 are coupled together by brazing, for example.

The housing 4 only needs to be formed in the shape of a box that houses the pair of fixed contacts 311, 321 and the moving contactor 8. Thus, the housing 4 does not have to be formed in the shape of a hollow rectangular parallelepiped as in this embodiment but may also be formed in the shape of a hollow elliptic cylinder or a hollow polygonal column, for example. That is to say, as used herein, the “box shape” refers to any shape in general which has a space to house the pair of fixed contacts 311, 321 and the moving contactor 8 inside, and therefore, does not have to be a rectangular parallelepiped shape. Furthermore, the housing 4 does not have to be made of a ceramic material but may also be made of an electrical insulating material such as glass or resin or may even be made of a metallic material. In any case, the housing 4 is suitably made of a non-magnetic material so as not to be magnetized with magnetism and turn into a magnetic body.

The flange 5 is made of a non-magnetic metallic material, which may be an austenitic stainless steel such as SUS304. The flange 5 may be formed in the shape of a hollow rectangular parallelepiped elongated in the rightward/leftward direction. The upper and lower surfaces of the flange 5 are open. The flange 5 is arranged between the housing 4 and the electromagnet device 10 (see FIGS. 1B and 2). The flange 5 is hermetically coupled to the housing 4 and a yoke upper plate 111 of the electromagnet device 10 as will be described later. This turns the internal space, surrounded with the housing 4, the flange 5, and the yoke upper plate 111, of the contact device 1 into a hermetically sealed space. The flange 5 does not have to be made of a non-magnetic material but may also be made of an alloy, such as 42 alloy, including iron as a main component.

The insulation plate 41 is made of a synthetic resin and has electrical insulation properties. The insulation plate 41 is formed in the shape of a rectangular plate. The insulation plate 41 is located under the moving contactor 8 to electrically insulate the moving contactor 8 from the electromagnet device 10. The insulation plate 41 has a through hole 42 at a middle portion thereof. In this embodiment, the through hole 42 is aligned with the through hole 83 of the moving contactor 8. The through hole 42 runs through the insulation plate 41 along the thickness thereof (i.e., in the upward/downward direction). The through hole 42 is provided to pass the shaft 15 therethrough.

The spacer 45 is formed in the shape of a cylinder. The spacer 45 may be made of a synthetic resin, for example. The spacer 45 is arranged between the electromagnet device 10 and the insulation plate 41. The upper end of the spacer 45 is coupled to the lower surface of the insulation plate 41 and the lower end of the spacer 45 is coupled to the electromagnet device 10. The insulation plate 41 is supported by the spacer 45. The spacer 45 has a hole to pass the shaft 15 therethrough.

The bus bars 21, 22 are made of a metallic material with electrical conductivity. The bus bars 21, 22 may be made of copper or a copper alloy, for example. The bus bars 21, 22 are each formed in the shape of a band. In this embodiment, the bus bars 21, 22 are formed by subjecting a metal plate to folding. One longitudinal end of the bus bar 21 may be electrically connected to the fixed terminal 31 of the contact device 1, for example. The other longitudinal end of the bus bar 21 may be electrically connected to a traveling battery, for example. One longitudinal end of the bus bar 22 may be electrically connected to the fixed terminal 32 of the contact device 1, for example. The other longitudinal end of the bus bar 22 may be electrically connected to the load, for example.

The bus bar 21 includes five electrical path pieces 211, 212, 213, 214, and 215. The electrical path piece 211 is mechanically connected to the fixed terminal 31. Specifically, the electrical path piece 211 has a generally square shape in a plan view and is caulked to the fixed terminal 31 at a caulking portion 35 of the fixed terminal 31. The electrical path piece 212 is joined to the electrical path piece 211 and is arranged on an extension that connects the fixed terminals 31, 32 together so as to extend downward from a left end of the electrical path piece 211. The electrical path piece 213 (first electrical path piece) is joined to the electrical path piece 212 and is arranged in front of the housing 4 so as to extend rightward (i.e., toward the fixed terminal 32 as viewed from the fixed terminal 31) from the front end of the electrical path piece 212. A thickness direction defined with respect to the electrical path piece 213 (i.e., the forward/backward direction) is perpendicular to the direction of movement of the moving contactor 8 (i.e., the upward/downward direction) (see FIGS. 1A and 2). The electrical path piece 214 (third electrical path piece) is joined to the electrical path piece 213 and is arranged on the extension that connects the fixed terminals 31, 32 together so as to extend backward from a right end of the electrical path piece 213. The electrical path piece 215 (second electrical path piece) is joined to the electrical path piece 214 and is arranged behind the housing 4 so as to extend leftward (i.e., toward the fixed terminal 31 as viewed from the fixed terminal 32) from the rear end of the electrical path piece 214. A thickness direction defined with respect to the electrical path piece 215 (i.e., the forward/backward direction) is perpendicular to the direction of movement of the moving contactor 8 (i.e., the upward/downward direction) (see FIGS. 1A and 2).

That is to say, the bus bar 21 is formed such that the electrical path pieces 212, 213, 214, and 215 thereof surround the housing 4 along the side surfaces (namely, the front, rear, right, and left surfaces) of the housing 4. Thus, when viewed from one end in the direction of movement of the moving contactor 8 (i.e., the upward/downward direction) (e.g., from over the moving contactor 8), the electrical path pieces 213 and 215 face each other in the forward/backward direction with the moving yoke 7 interposed between them, and the electrical path pieces 212 and 214 face each other in the rightward/leftward direction with the moving yoke 7 interposed between them.

In other words, the electrical path pieces 213 and 215 have a shape extending in the direction in which the electric current I flows through the moving contactor 8. In this embodiment, the direction in which the electric current I flows through the moving contactor 8 is an extension of a line that connects together the respective centers of the moving contacts 81, 82 on the upper surface of the moving contactor 8, i.e., the rightward/leftward direction. Thus, the direction in which the electric current I flows through the electrical path pieces 213 and 215 is aligned with the direction in which the electric current flows through the moving contactor 8.

As used herein, the phrase “extending in the direction in which the electric current flows” refers to an arrangement in which the electrical path piece 213 (or 215) is provided such that the angle defined by the electrical path piece 213 (or 215) extending with respect to the direction in which the electric current flows through the moving contactor 8 of the contact device 1 falls within a predetermined range (e.g., from 0 to 45 degrees). That is to say, the electrical path piece 213 (or 215) is provided such that out of vectors of the electric current flowing through the electrical path piece 213 (or 215), a component parallel to the vector of the electric current flowing through the moving contactor 8 of the contact device 1 becomes greater than a component perpendicular to the vector of the electric current flowing through the moving contactor 8 of the contact device 1. In addition, the angle defined by the electrical path piece 213 (or 215) extending with respect to the direction in which the electric current flows through the moving contactor 8 of the contact device 1 suitably falls within a predetermined range (e.g., from 0 to 25 degrees). In a specific example, the electrical path piece 213 (or 215) of the contact device 1 extends parallel to the direction in which the electric current flows through the moving contactor 8 of the contact device 1.

In addition, in the direction of movement of the moving contactor 8 (i.e., in the upward/downward direction), the bus bar 21 is arranged over the moving yoke 7 when the moving contactor 8 is currently located at the closed position (i.e., located on the same side as the fixed contacts 311, 321 with respect to the moving contactor 8) (see FIG. 2). Specifically, the lower end 210 of the bus bar 21 is located over the respective upper ends 721, 731 of the moving yoke 7 when the moving contactor 8 is currently located at the closed position.

Furthermore, the bus bar 21 is arranged, in the direction of movement of the moving contactor 8 (i.e., in the upward/downward direction), over the moving contactor 8 that is currently located at the closed position (i.e., located on the same side as the fixed contacts 311, 321 with respect to the moving contactor 8) (see FIG. 2). Specifically, the lower end 210 of the bus bar 21 is located over the moving contactor 8 that is currently located at the closed position. In other words, while the moving contactor 8 is currently located at the closed position, at least part of the electrical path piece 213 and at least part of the electrical path piece 215 are located on the same side as the fixed contacts 311, 321 with respect to the moving contactor 8 in the direction of movement of the moving contactor 8.

The bus bar 22 includes an electrical path piece 221. The electrical path piece 221 is mechanically connected to the fixed terminal 32. Specifically, the electrical path piece 221 has a generally square shape in a plan view and is caulked to the fixed terminal 32 at a caulking portion 36 of the fixed terminal 32. The electrical path piece 221 is located over the electrical path piece 214 of the bus bar 21 and is arranged to extend rightward (i.e., from the fixed terminal 31 toward the fixed terminal 32).

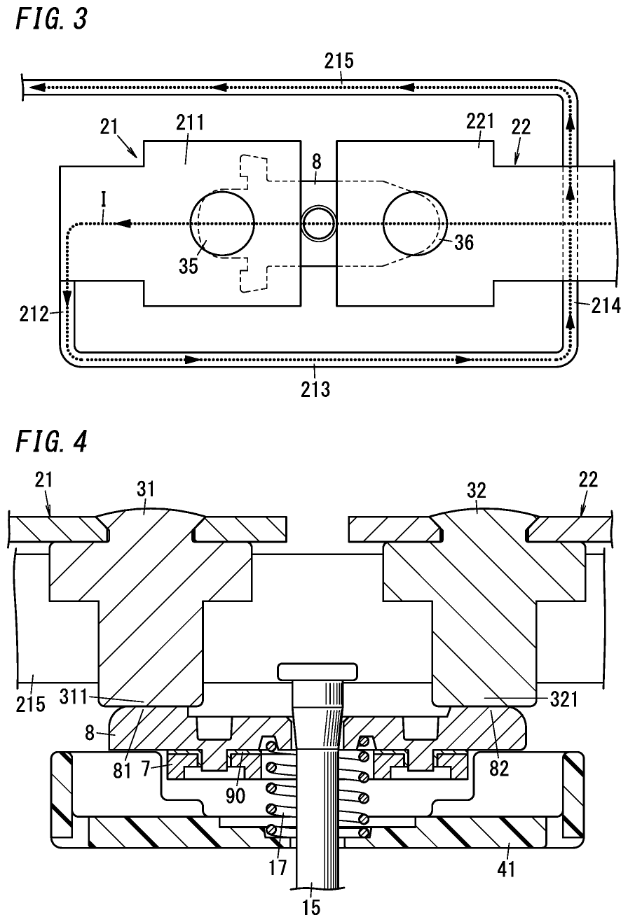

In this embodiment, the electric current I flowing through the bus bar 22 is supposed to be input to the fixed terminal 32 and the input electric current I is supposed to be output through the fixed terminal 31. In that case, the electric current I flows, in this order, through the electrical path piece 221, the fixed terminal 32, the moving contactor 8, the fixed terminal 31, the electrical path piece 211, the electrical path piece 212, the electrical path piece 213, the electrical path piece 214, and the electrical path piece 215 (see FIG. 3). When viewed from one end in the direction of movement of the moving contactor 8 (e.g., from over the moving contactor 8), the electric current flows counterclockwise through the bus bar 21. The electric current I flows rightward through the electrical path piece 213 (i.e., from the fixed terminal 31 toward the fixed terminal 32). The electric current I flows leftward through the electrical path piece 215 (i.e., from the fixed terminal 32 toward the fixed terminal 31). That is to say, the electric current I flows through the electrical path pieces 213 and 215 in mutually opposite directions. Conversely, when the electric current I flows through the moving contactor 8 from the fixed terminal 31 toward the fixed terminal 32, the electric current I flows clockwise through the bus bar 21 when viewed from one end in the direction of movement of the moving contactor 8 (i.e., from over the moving contactor 8).

(1.3) Electromagnet Device

Next, a configuration for the electromagnet device 10 will be described.

The electromagnet device 10 is arranged under the moving contactor 8. As shown in FIGS. 1A and 1B, the electromagnet device 10 includes a stator 12, the mover 13, and the excitation coil 14. When the excitation coil 14 is energized, the electromagnet device 10 has the mover 13 attracted toward the stator 12 by a magnetic field generated by the excitation coil 14, thereby moving the mover 13 upward.

In this embodiment, the electromagnet device 10 includes not only the stator 12, the mover 13, and the excitation coil 14 but also a yoke 11 including the yoke upper plate 111, the shaft 15, a cylindrical body 16, a contact pressure spring 17, a return spring 18, and a coil bobbin 19 as well.

The stator 12 is a fixed iron core formed in the shape of a cylinder protruding downward from a central region of the lower surface of the yoke upper plate 111. The upper end of the stator 12 is secured to the yoke upper plate 111.

The mover 13 is a moving iron core also formed in the shape of a cylinder. The mover 13 is arranged under the stator 12 such that the upper end face of the mover 13 faces the lower end face of the stator 12. The mover 13 is configured to be movable in the upward/downward direction. Specifically, the mover 13 moves back and forth between an excitation position where the upper end face thereof is in contact with the lower end face of the stator 12 (see FIGS. 1B and 2) and a non-excitation position where the upper end face thereof is out of contact with the lower end face of the stator 12.

The excitation coil 14 is arranged under the housing 4 such that its center axis is aligned with the upward/downward direction. The stator 12 and the mover 13 are arranged inside the excitation coil 14.

The yoke 11 is arranged to surround the excitation coil 14. The yoke 11 forms, along with the stator 12 and the mover 13, a magnetic circuit, through which magnetic fluxes, produced when the excitation coil 14 is energized, pass. Thus, the yoke 11, the stator 12, and the mover 13 are all made of a magnetic material (such as a ferromagnetic body). The yoke upper plate 111 forms part of the yoke 11. In other words, at least part of the yoke 11 (i.e., the yoke upper plate 111) is located between the excitation coil 14 and the moving contactor 8.

The contact pressure spring 17 is arranged between the lower surface of the moving contactor 8 and the upper surface of the insulation plate 41. The contact pressure spring 17 is a coil spring that biases the moving contactor 8 upward (see FIG. 1B).

At least part of the return spring 18 is arranged inside the stator 12. The return spring 18 is a coil spring that biases the mover 13 downward (toward the non-excitation position). One end of the return spring 18 is connected to the upper end face of the mover 13 and the other end of the return spring 18 is connected to the yoke upper plate 111 (see FIG. 1B).

The shaft 15 is made of a non-magnetic material. The shaft 15 is formed in the shape of a round rod extending in the upward/downward direction. The shaft 15 transmits the driving force, generated by the electromagnet device 10, to the contact device 1 provided over the electromagnet device 10. The shaft 15 passes through the through hole 83, the through hole 71, the inside of the contact pressure spring 17, the through hole 42, the through hole cut through a central region of the yoke upper plate 111, the inside of the stator 12, and the inside of the return spring 18 to have the lower end thereof fixed onto the mover 13.

The coil bobbin 19 is made of a synthetic resin. The excitation coil 14 is wound around the coil bobbin 19.

The cylindrical body 16 is formed in the shape of a bottomed cylinder with an open upper surface. The upper end (peripheral portion around the opening) of the cylindrical body 16 is bonded onto the lower surface of the yoke upper plate 111. This allows the cylindrical body 16 to restrict the direction of movement of the mover 13 to the upward/downward direction and also define the non-excitation position of the mover 13. The cylindrical body 16 is hermetically bonded onto the lower surface of the yoke upper plate 111. This allows, even when a through hole is cut through the yoke upper plate 111, the internal space, surrounded with the housing 4, the flange 5, and the yoke upper plate 111, of the contact device 1 to be kept sealed hermetically.

This configuration allows the moving contactor 8 to move up and down in the upward/downward direction as the mover 13 moves up and down in the upward/downward direction under the driving force generated by the electromagnet device 10.

(2) Operation

Next, it will be described briefly how an electromagnetic relay 100, including the contact device 1 and electromagnet device 10 with such configurations, operates.

While the excitation coil 14 is supplied with no electric current (i.e., not energized), no magnetic attractive force is generated between the mover 13 and the stator 12. Thus, in such a situation, the mover 13 is located at the non-excitation position under the spring force applied by the return spring 18. At this time, the shaft 15 has been pulled down to restrict the upward movement of the moving contactor 8. This causes the moving contactor 8 to be located at the open position, which is the lower end position of its movable range. This brings the pair of moving contacts 81, 82 out of contact with the pair of fixed contacts 311, 321, respectively, thus turning the contact device 1 open. In this state, the pair of fixed terminals 31, 32 are not electrically conductive with each other.

On the other hand, when the excitation coil 14 is energized (i.e., supplied with an electric current), magnetic attractive force is generated between the mover 13 and the stator 12, thus causing the mover 13 to be pulled upward by overcoming the spring force applied by the return spring 18 to reach the excitation position. At this time, the shaft 15 is pushed upward, thus canceling the shaft's 15 restriction on the upward movement of the moving contactor 8. Then, the contact pressure spring 17 biases the moving contactor 8 upward, thus causing the moving contactor 8 to move toward the closed position at the upper end of its movable range. This brings the pair of moving contacts 81, 82 into contact with the pair of fixed contacts 311, 321, respectively, thus turning the contact device 1 closed. In this state, the contact device 1 is closed, and therefore, the pair of fixed terminals 31, 32 are electrically conductive with each other.

This allows the electromagnet device 10 to control the attractive force to be applied onto the mover 13 by selectively energizing the excitation coil 14 and to generate driving force for changing the state of the contact device 1 from the open state to the closed state, and vice versa, by moving the mover 13 up and down in the upward/downward direction.

(3) Advantages

When the excitation coil 14 is energized (or supplied with an electric current), the mover 13 moves from the non-excitation position to the excitation position in the electromagnet device 10 as described above. At this time, the driving force generated by the electromagnet device 10 causes the moving contactor 8 to move upward from the open position toward the closed position. This brings the moving contacts 81, 82 into contact with the fixed contacts 311, 321, respectively, thus turning the contact device 1 closed. When the contact device 1 is closed, the contact pressure spring 17 presses the moving contacts 81, 82 against the fixed contacts 311, 321, respectively.

In some cases, when the contact device 1 is closed, electromagnetic repulsion that brings the moving contacts 81, 82 out of contact with the fixed contacts 311, 321, respectively, may be caused by an electric current flowing through the contact device 1 (between the fixed terminals 31, 32) That is to say, when an electric current flows through the contact device 1, the Lorenz force sometimes causes the electromagnetic repulsion to the moving contactor 8 in such a direction as to move the moving contactor 8 from the closed position toward the open position (i.e., downward). The electromagnetic repulsion is ordinarily less than the spring force applied by the contact pressure spring 17, thus allowing the moving contactor 8 to keep the moving contacts 81, 82 in contact with the fixed contacts 311, 321, respectively. Nevertheless, when a significant amount of electric current (of about 6 kA, for example) such as a short-circuit current flows (as an abnormal electric current) through the contact device 1, the electromagnetic repulsion applied to the moving contactor 8 could be greater than the spring force applied by the contact pressure spring 17. In this embodiment, an electric current flowing through the bus bar 21 is used as a countermeasure against such electromagnetic repulsion.

The contact device 1 according to this embodiment is configured such that the electrical path pieces 212, 213, 214, and 215 of the bus bar 21 surround the housing 4. Thus, when the bus bar 21 is energized, a magnetic field, of which the magnetic fluxes φ10 have a direction aligned with the direction of movement of the moving contactor 8 and the moving yoke 7 (i.e., the upward/downward direction), is generated inside the housing 4 (see FIG. 2). In this embodiment, when viewed from one end in the direction of movement of the moving contactor 8 (e.g., from over the moving contactor 8), an electric current I flows counterclockwise through the bus bar 21, and therefore, the direction of the magnetic fluxes φ10 turns upward inside the housing 4. The moving yoke 7 is magnetized by the magnetic field generated by the bus bar 21. This causes magnetic attractive forces to be produced between the bus bar 21 and the moving yoke 7. Specifically, the moving yoke 7 is attracted toward the bus bar 21 by the magnetic field generated when the bus bar 21 is energized. The bus bar 21 is arranged over the moving yoke 7. Since the moving yoke 7 is provided for the moving contactor 8, the magnetic attractive forces between the bus bar 21 and the moving yoke 7 apply upward force to the moving contactor 8. This increases the force with which the moving contactor 8 pushes the fixed contacts 311, 321 upward, thus increasing the stability of connection between the moving contacts 81, 82 and the fixed contacts 311, 321. This allows, even if an abnormal electric current such as a short-circuit current flows through the contact device 1, the conditions of connection between the moving contacts 81, 82 and the fixed contacts 311, 321 to be further stabilized.

In the example described above, the electric current I is supposed to flow through the moving contactor 8 from the fixed terminal 32 toward the fixed terminal 31. However, this is only an example and should not be construed as limiting. Alternatively, the electric current I may flow through the moving contactor 8 from the fixed terminal 31 toward the fixed terminal 32. In that case, the electric current I flows clockwise through the bus bar 21 and a magnetic field with downward magnetic fluxes is generated inside the housing 4. This magnetic field magnetizes the moving yoke 7, thus causing magnetic attractive forces to be produced between the bus bar 21 and the moving yoke 7 as in the example described above.

(4) Variations

Next, variations of the first embodiment will be described. In the following description, any constituent element of the variations, having the same function as a counterpart of the first embodiment described above, will be designated by the same reference numeral as that counterpart's, and description thereof will be omitted herein as appropriate.

In the first embodiment described above, the moving yoke 7 is provided on the lower surface of the moving contactor 8 so as to have its position fixed with respect to the moving contactor 8. However, this configuration is only an example and should not be construed as limiting.

Alternatively, the moving yoke 7 may be provided on the upper surface of the moving contactor 8 so as to have its position fixed with respect to the moving contactor 8.

Optionally, the moving yoke 7 may also be provided so as to be movable with respect to the moving contactor 8. For example, an alternative moving yoke 7a may be provided for a holder 150 that forms part of an electromagnetic relay (see FIG. 6). The holder 150 may be configured as a rectangular cylinder, of which the right and left sides are open, for example, and may be combined with the moving contactor 8 such that the moving contactor 8 runs through the holder 150 in the rightward/leftward direction. The contact pressure spring 17a is arranged between a bottom wall 151 of the holder 150 and the moving contactor 8. That is to say, the moving contactor 8 has its central portion in the rightward/leftward direction held by the holder 150. The holder 150 is secured to the upper end of the shaft 15. The moving yoke 7a is secured to an upper wall 152 of the holder 150 between the moving contactor 8 and the upper wall 152.

When the excitation coil 14 is energized, the shaft 15 is pushed upward, thus causing the holder 150 to move upward. This upward movement causes the moving contactor 8 to move upward as well, thus bringing the pair of moving contacts 81, 82 to the closed position where the pair of moving contacts 81, 82 are in contact with the pair of fixed contacts 311, 321, respectively.

The magnetic field generated when the bus bar 21 is energized attracts the moving yoke 7a toward the bus bar 21 and applies upward force to the moving yoke 7a. The moving yoke 7a is provided for the holder 150. Therefore, the upward force applied to the moving yoke 7a is transmitted to the moving contactor 8 via the holder 150 and the contact pressure spring 17a. Specifically, as the holder 150 moves upward, the contact pressure spring 17a is further compressed, thus increasing the spring force applied from the contact pressure spring 17a to the moving contactor 8. This allows, even when an abnormal electric current such as a short-circuit current flows through the contact device 1, the conditions of connection between the moving contacts 81, 82 and the fixed contacts 311, 321 to be further stabilized.

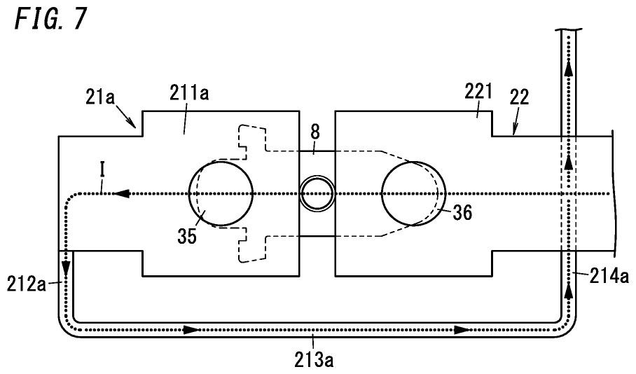

Also, the bus bar 21 is configured such that the electrical path pieces 212, 213, 214, and 215 surround the housing 4 (moving yoke 7) in the embodiment described above. However, this is only an example and should not be construed as limiting. Rather, the bus bar 21 may include at least one pair of electrical path pieces that face each other with the moving yoke 7 interposed when viewed from one end in the direction of movement of the moving contactor 8 (i.e., in the upward/downward direction). For example, an alternative bus bar 21a includes electrical path pieces 211a, 212a, 213a, and 214a (see FIG. 7). The bus bar 21a includes every one of the electrical path pieces 211, 212, 213, 214, and 215 of the bus bar 21 but the electrical path piece 215, and the electrical path piece 214a extends in the forward/backward direction. In the bus bar 21a, when viewed from one end in the direction of movement of the moving contactor 8 (i.e., in the upward/downward direction), the electrical path pieces 212a (first electrical path piece) and 214a (second electrical path piece) face each other in the rightward/leftward direction with the moving yoke 7 interposed between them.

The electric current I flows through the electrical path pieces 212a and 214a in mutually opposite directions. The direction in which the electric current I flows through the electrical path piece 213a (third electrical path piece) is opposite from the direction in which the electric current I flows through the moving contactor 8.

(Other Variations)

Other variations will be enumerated one after another. Any of the variations to be described below may be combined as appropriate with the embodiment described above (including the variations thereof).

In the exemplary embodiment described above, the housing 4 is configured to hold the fixed terminals 31, 32 with the fixed terminals 31, 32 partially exposed. However, this is only an example and should not be construed as limiting. Alternatively, the housing 4 may house the fixed terminals 31, 32 entirely inside itself. That is to say, the housing 4 only needs to be configured to house the fixed contacts 311, 321 and the moving contactor 8 to say the least. Optionally, the bus bar 21 may be housed inside the housing 4 at least partially.

Also, in the exemplary embodiment described above, the contact device may include no capsule yokes. When provided, the capsule yokes could weaken the attractive forces between the bus bar 21 and the moving yoke 7. Thus, removing the capsule yokes curbs such a decrease in attractive forces due to the presence of capsule yokes, thus eventually increasing the force with which the moving contactor 8 is pushed upward.

Also, in the exemplary embodiment described above, the bus bar 21 is configured to, when energized, generate a magnetic field that magnetizes the moving yoke 7. However, this is only an example and should not be construed as limiting. Alternatively, the bus bar 22 may also be configured to, when energized, generate a magnetic field that magnetizes the moving yoke 7 just as the bus bar 21 does. Still alternatively, both of these bus bars 21, 22 may be configured to, when energized, generate a magnetic field that magnetizes the moving yoke 7.

Furthermore, in the exemplary embodiment described above, the bus bar 21 is electrically connected to the fixed terminal 31. However, this is only an example and should not be construed as limiting. Alternatively, the bus bar is not electrically connected to the fixed terminal 31 but may be configured to generate, when energized, a magnetic field that magnetizes the moving yoke 7.

Furthermore, in the exemplary embodiment described above, the electromagnetic relay is supposed to be a so-called “normally OFF” electromagnetic relay, of which the moving contactor 8 is located at the open position while the excitation coil 14 is not energized. However, this is only an example and should not be construed as limiting. Alternatively, the electromagnetic relay may also be a normally ON electromagnetic relay.

Furthermore, in the exemplary embodiment described above, the number of moving contacts held by the moving contactor 8 is two. However, this is only an example and should not be construed as limiting. The number of the moving contacts held by the moving contactor 8 may also be one or even three or more. Likewise, the number of the fixed terminals (and fixed contacts) does not have to be two but may also be one or even three or more.

Furthermore, in the exemplary embodiment described above, the contact device is implemented as a plunger type contact device. Alternatively, the contact device may also be implemented as a hinged contact device.

Furthermore, in the exemplary embodiment described above, the bus bar is caulked to, and thereby mechanically connected to, the fixed terminals 31, 32. However, this is only an example and should not be construed as limiting. Alternatively, the bus bar may also be mechanically connected with screws onto the fixed terminals 31, 32. Still alternatively, the bus bar may also be coupled to the fixed terminals 31, 32 by welding, brazing, or any other suitable method.

Furthermore, in the exemplary embodiment described above, the arc extinction magnets are arranged outside the housing 4 (i.e., between the capsule yokes and the housing 4). However, this is only an example and should not be construed as limiting. Alternatively, the arc extinction magnets may also be arranged inside the housing 4.

Furthermore, none of the yokes, arc extinction magnets, and capsule yokes is an essential constituent element for the contact device according to the exemplary embodiment.

### Second Embodiment

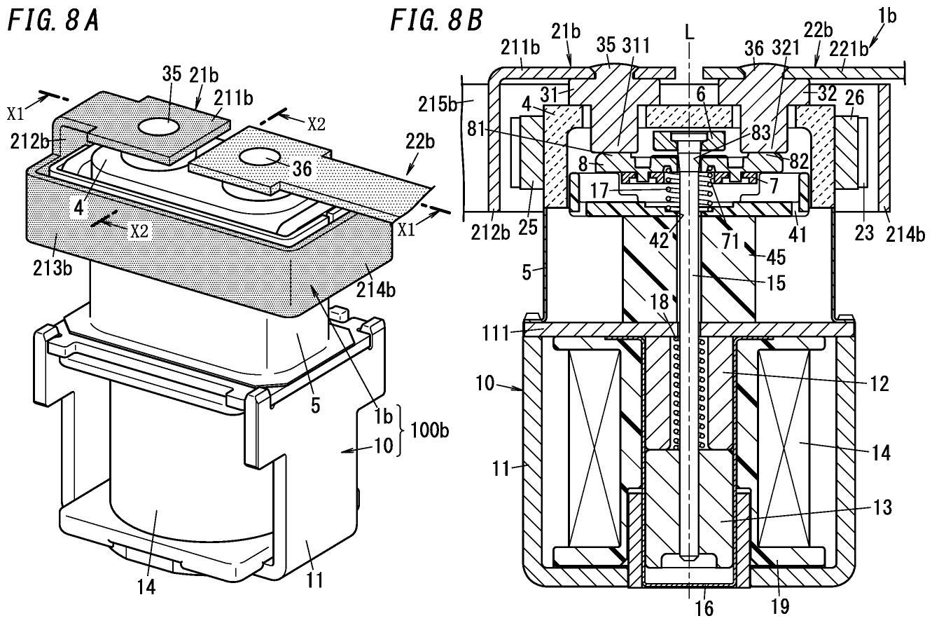

A contact device 1b according to a second embodiment will be described with reference to FIGS. 8-16.

The contact device 1b according to this embodiment further includes a fixed yoke 6, which is a major difference from the first embodiment described above. The following description of the second embodiment will be focused on the difference from the first embodiment. In the following description, any constituent element of this second embodiment, having the same function as a counterpart of the first embodiment described above, will be designated by the same reference numeral as that counterpart's, and description thereof will be omitted herein as appropriate.

An electromagnetic relay 100b according to this embodiment includes the contact device 1b and the electromagnet device 10 that has already been described for the first embodiment.

The fixed yoke 6 is housed, along with the pair of fixed contacts 311, 321, the moving contactor 8, and the moving yoke 7, in the housing 4.

The fixed yoke 6 is configured as a ferromagnetic body and may be made of a metallic material such as iron. The fixed yoke 6 is secured to the tip (upper end) of the shaft 15. The shaft 15 runs through the moving contactor 8 through the through hole 83 thereof and the tip (upper end) of the shaft 15 protrudes upward from the upper surface of the moving contactor 8. Thus, the fixed yoke 6 is located over the moving contactor 8 (see FIG. 8B). Specifically, in the direction of movement of the moving contactor 8, the fixed yoke 6 is located on the same side as the fixed contacts 311, 321 with respect to the moving contactor 8.

When the moving contactor 8 is currently located at the closed position, a predetermined gap L1 is left between the moving contactor 8 and the fixed yoke 6 (see FIG. 11). That is to say, when the moving contactor 8 is located at the closed position, the fixed yoke 6 is spaced apart from the moving contactor 8 by the gap L1 in the upward/downward direction. For example, if the moving contactor 8, the shaft 15, and the fixed yoke 6 are electrically insulated from each other at least partially, then electrical insulation is ensured between the moving contactor 8 and the fixed yoke 6.

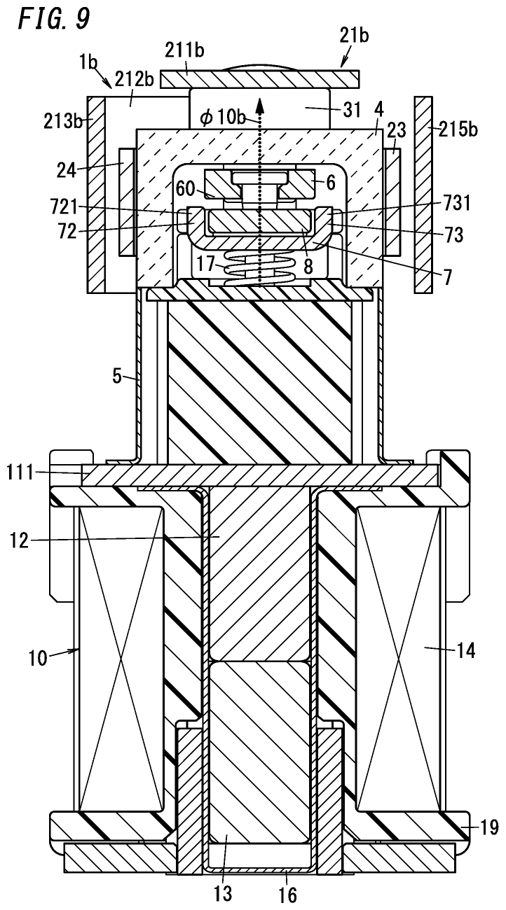

The moving yoke 7 has, at both ends in the forward/backward direction, a pair of protrusions 72, 73 protruding upward (see FIG. 9). In other words, at both ends in the forward/backward direction of the upper surface of the moving yoke 7, provided are protrusions 72, 73 protruding in the direction of movement of the moving contactor 8 from the open position toward the closed position (i.e., upward in this embodiment). That is to say, at least part of the moving yoke 7 is located opposite from the fixed contacts 311, 321 with respect to the moving contactor 8 in the direction of movement of the moving contactor 8.

When the moving yoke 7 has such a shape, the tip surface (i.e., upper end face) of the front protrusion 72, out of the pair of protrusions 72, 73, is abutted on a frontend portion of the fixed yoke 6, while the tip surface (i.e., upper end face) of the rear protrusion 73, out of the pair of protrusions 72, 73, is abutted on a rear end portion of the fixed yoke 6.

The bus bar 21b includes five electrical path pieces 211b, 212b, 213b, 214b, and 215b. The electrical path piece 211b is mechanically connected to the fixed terminal 31. Specifically, the electrical path piece 211b has a generally square shape in a plan view and is caulked to the fixed terminal 31 at a caulking portion 35 of the fixed terminal 31. The electrical path piece 212b is joined to the electrical path piece 211b and is arranged on an extension that connects the fixed terminals 31, 32 together so as to extend downward from a left end of the electrical path piece 211b. The electrical path piece 213b (first electrical path piece) is joined to the electrical path piece 212b and is arranged in front of the housing 4 so as to extend rightward (i.e., toward the fixed terminal 32 as viewed from the fixed terminal 31) from the front end of the electrical path piece 212b. A thickness direction defined with respect to the electrical path piece 213b (i.e., the forward/backward direction) is perpendicular to the direction of movement of the moving contactor 8 (i.e., the upward/downward direction) (see FIGS. 8A and 9). The electrical path piece 214b (third electrical path piece) is joined to the electrical path piece 213b and is arranged on the extension that connects the fixed terminals 31, 32 together so as to extend backward from a right end of the electrical path piece 213b. The electrical path piece 215b (second electrical path piece) is joined to the electrical path piece 214b and is arranged behind the housing 4 so as to extend leftward (i.e., toward the fixed terminal 31 as viewed from the fixed terminal 32) from the rear end of the electrical path piece 214b. A thickness direction defined with respect to the electrical path piece 215b (i.e., the forward/backward direction) is perpendicular to the direction of movement of the moving contactor 8 (i.e., the upward/downward direction) (see FIGS. 8A and 9).

That is to say, the bus bar 21b is formed such that the electrical path pieces 212b, 213b, 214b, and 215b thereof surround the housing 4 along the side surfaces (namely, the front, rear, right, and left surfaces) of the housing 4. Thus, when viewed from one end in the direction of movement of the moving contactor 8 (i.e., the upward/downward direction) (e.g., from over the moving contactor 8), the electrical path pieces 213b and 215b face each other in the forward/backward direction with the moving yoke 7 interposed between them, and the electrical path pieces 212b and 214b face each other in the rightward/leftward direction with the moving yoke 7 interposed between them.

In other words, the electrical path pieces 213b and 215b have a shape extending in the direction in which the electric current I flows through the moving contactor 8. In this embodiment, the direction in which the electric current I flows through the moving contactor 8 is an extension of a line that connects together the respective centers of the moving contacts 81, 82 on the upper surface of the moving contactor 8, i.e., the rightward/leftward direction. Thus, the direction in which the electric current I flows through the electrical path pieces 213b and 215b is aligned with the direction in which the electric current flows through the moving contactor 8.

In addition, the upper end of the bus bar 21 is located over the moving contactor 8 when the moving contactor 8 is currently located at the closed position. In other words, when the moving contactor 8 is located at the closed position, at least part of the electrical path piece 213b and at least part of the electrical path piece 215b are located on the same side as the fixed contacts 311, 321 with respect to the moving contactor 8 in the direction of movement of the moving contactor 8 (i.e., in the upward/downward direction).

The bus bar 22b includes an electrical path piece 221b. The electrical path piece 221b is mechanically connected to the fixed terminal 32. Specifically, the electrical path piece 221b has a generally square shape in a plan view and is caulked to the fixed terminal 32 at a caulking portion 36 of the fixed terminal 32. The electrical path piece 221b is located over the electrical path piece 214b of the bus bar 21b and is arranged to extend rightward (i.e., from the fixed terminal 31 toward the fixed terminal 32).

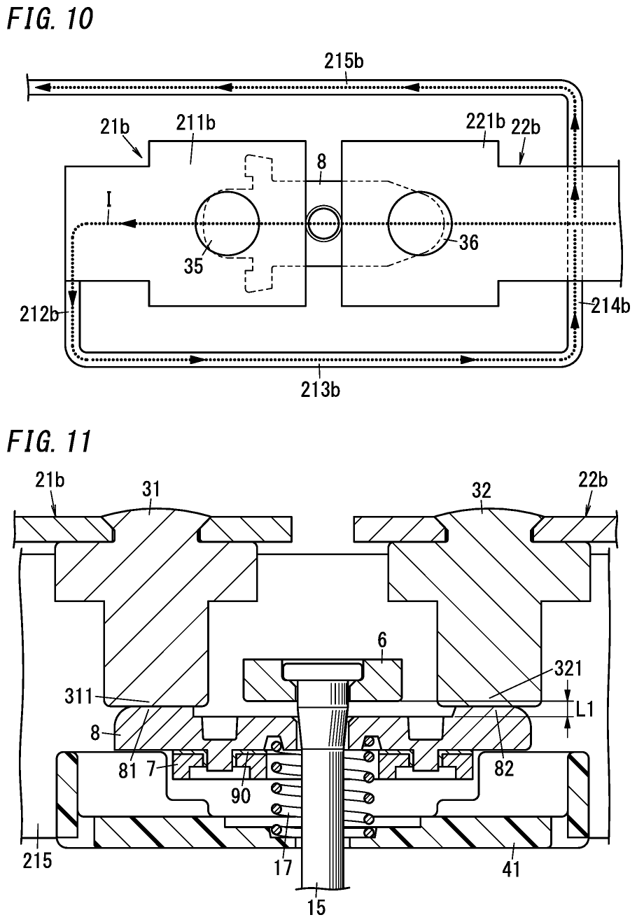

In this embodiment, the electric current I flowing through the bus bar 22b is supposed to be input to the fixed terminal 32 and the input electric current I is supposed to be output through the fixed terminal 31. In that case, the electric current I flows, in this order, through the electrical path piece 221b, the fixed terminal 32, the moving contactor 8, the fixed terminal 31, the electrical path piece 211b, the electrical path piece 212b, the electrical path piece 213b, the electrical path piece 214b, and the electrical path piece 215b (see FIG. 10). When viewed from one end in the direction of movement of the moving contactor 8 (e.g., from over the moving contactor 8), the electric current I flows counterclockwise through the bus bar 21b. The electric current I flows rightward through the electrical path piece 213b (i.e., from the fixed terminal 31 toward the fixed terminal 32). The electric current I flows leftward through the electrical path piece 215b (i.e., from the fixed terminal 32 toward the fixed terminal 31). That is to say, the electric current I flows through the electrical path pieces 213b and 215b in mutually opposite directions. Conversely, when the electric current I flows through the moving contactor 8 from the fixed terminal 31 toward the fixed terminal 32, the electric current I flows clockwise through the bus bar 21b when viewed from one end in the direction of movement of the moving contactor 8 (i.e., from over the moving contactor 8).

(Advantages of Second Embodiment)

The contact device 1b according to this embodiment is configured such that the electrical path pieces 212b, 213b, 214b, and 215b of the bus bar 21b surround the housing 4 (including the fixed yoke 6 and the moving yoke 7). Thus, when the bus bar 21b is energized, a magnetic field, of which the magnetic fluxes φ10 have a direction aligned with the direction of movement of the moving contactor 8 and the moving yoke 7 (i.e., the upward/downward direction), is generated inside the housing 4 (see FIG. 9). In this embodiment, when viewed from one end in the direction of movement of the moving contactor 8 (e.g., from over the moving contactor 8), an electric current I flows counterclockwise through the bus bar 21b, and therefore, the direction of the magnetic fluxes φ10 turns upward inside the housing 4. The fixed yoke 6 and the moving yoke 7 are magnetized by the magnetic field generated by the bus bar 21b. This causes magnetic attractive forces to be produced between the fixed yoke 6 and the moving yoke 7. Specifically, the magnetic field generated by the bus bar 21b turns the lower end 60 of the fixed yoke 6 into S pole and also turns the upper ends 721, 731 of the moving yoke 7 into N pole, thus generating magnetic attractive forces between the fixed yoke 6 and the moving yoke 7. That is to say, the bus bar 21b generates, when energized, a magnetic field that magnetizes the fixed yoke 6 and the moving yoke 7 such that respective poles, facing each other, of the fixed yoke 6 and the moving yoke 7 have mutually opposite polarities. The fixed yoke 6 is provided at the tip (upper end) of the shaft 15 and has its position in the upward/downward direction fixed when the moving contactor 8 is located at the closed position. Since the moving yoke 7 is provided for the moving contactor 8, the magnetic attractive forces produced between the fixed yoke 6 and the moving yoke 7 cause upward force to be applied to the moving contactor 8. This increases the force with which the moving contactor 8 pushes the fixed contacts 311, 321 upward, thus increasing the stability of connection between the moving contacts 81, 82 and the fixed contacts 311, 321. This allows, even if an abnormal electric current such as a short-circuit current flows through the contact device 1, the conditions of connection between the moving contacts 81, 82 and the fixed contacts 311, 321 to be further stabilized.

In the example described above, the electric current I is supposed to flow through the moving contactor 8 from the fixed terminal 32 toward the fixed terminal 31. However, this is only an example and should not be construed as limiting. Alternatively, the electric current I may flow through the moving contactor 8 from the fixed terminal 31 toward the fixed terminal 32. In that case, the electric current I flows clockwise through the bus bar 21b and a magnetic field with downward magnetic fluxes is generated inside the housing 4. This magnetic field magnetizes the fixed yoke 6 and the moving yoke 7, thus causing magnetic attractive forces to be produced between the fixed yoke 6 and the moving yoke 7 as in the example described above.

(Variations of Second Embodiment)

Next, variations of the second embodiment will be described. In the following description, any constituent element of the variations, having the same function as a counterpart of the second embodiment described above, will be designated by the same reference numeral as that counterpart's, and description thereof will be omitted herein as appropriate.

In the second embodiment, the fixed yoke 6 is provided at the tip of the shaft 15. That is to say, the fixed yoke 6 is configured to be movable in the direction of movement of the moving contactor 8. However, this configuration is only an example and should not be construed as limiting.

Alternatively, the fixed yoke 6 may have its relative position fixed with respect to the fixed terminals 31, 32, no matter whether the moving contactor 8 (moving yoke 7) moves or not.

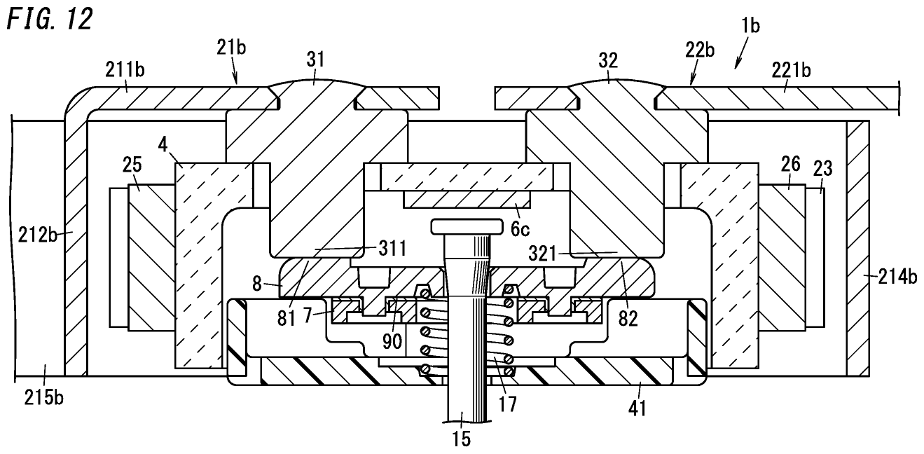

For example, the contact device 1 may include the fixed yoke 6c shown in FIG. 12 instead of the fixed yoke 6. The fixed yoke 6c is fixed on a region of an inner surface of the housing 4. In this example, the fixed yoke 6c is fixed at such a position as to face the moving contactor 8 from over the moving contactor 8.

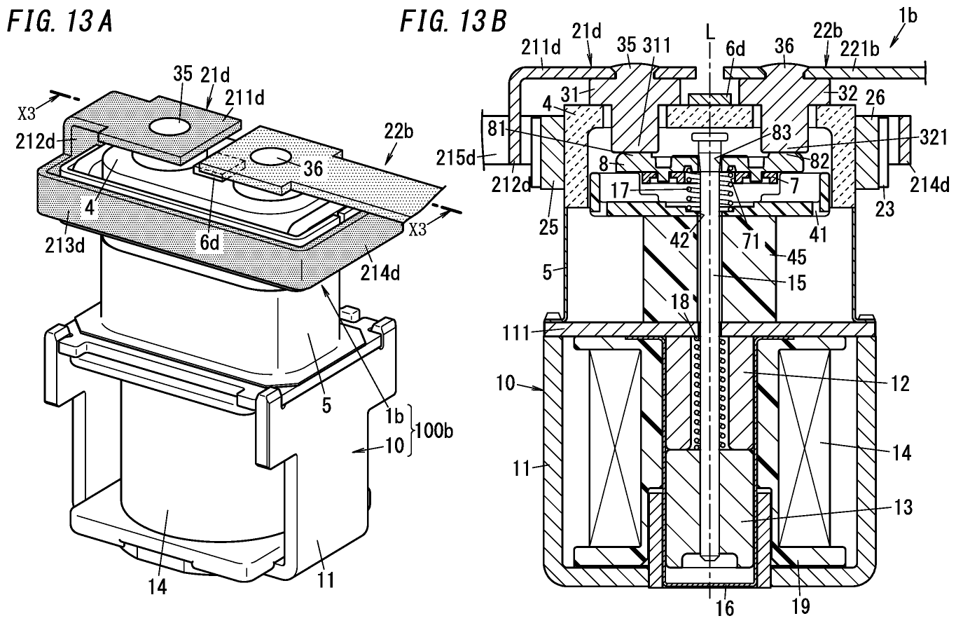

Alternatively, the contact device 1b may include the fixed yoke 6d shown in FIGS. 13A and 13B instead of the fixed yoke 6. The fixed yoke 6d is fixed on a region of the outer surface of the housing 4. In this example, the fixed yoke 6d is fixed at such a position as to face, via an upper wall of the housing 4, the moving contactor 8 from over the moving contactor 8. In addition, in the example shown in FIGS. 13A and 13B, the contact device 1b includes a bus bar 21d instead of the bus bar 21. The bus bar 21d includes electrical path pieces 211d, 212d, 213d, 214d, and 215d. The bus bar 21d is configured such that in the direction of movement of the moving contactor 8 (i.e., in the upward/downward direction), the electrical path pieces 213d, 214d, and 215d are located between the fixed yoke 6d and the moving yoke 7 that is currently located at the closed position.

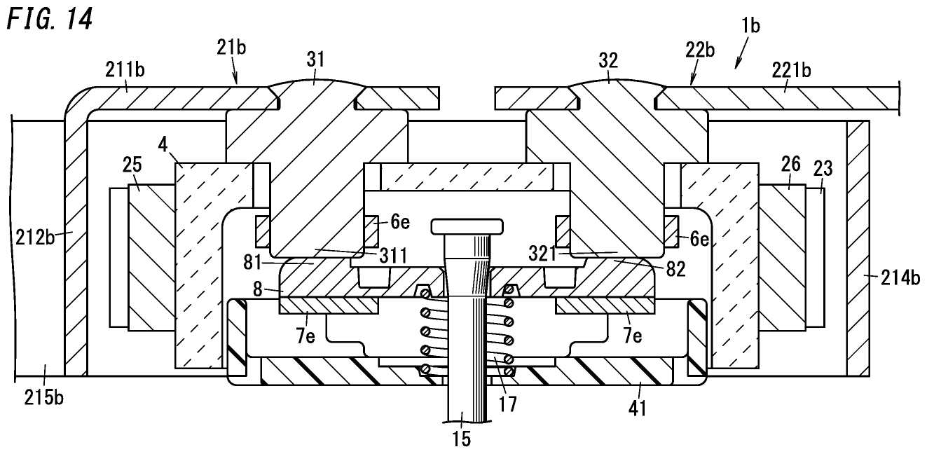

Still alternatively, the contact device 1b may include the pair of fixed yokes 6e shown in FIG. 14 instead of the fixed yoke 6. Each of the pair of fixed yokes 6e is formed in the shape of a ring. One fixed yoke 6e is passed through, and fixed onto, the fixed terminal 31. The other fixed yoke 6e is passed through, and fixed onto, the fixed terminal 32. An insulating layer with electrical insulation properties is provided between the one fixed yoke 6e and the fixed terminal 31, thereby ensuring electrical insulation between the fixed yoke 6e and the fixed terminal 31. Likewise, an insulating layer with electrical insulation properties is provided between the other fixed yoke 6e and the fixed terminal 32, thereby ensuring electrical insulation between the fixed yoke 6e and the fixed terminal 32. In addition, the contact device 1b includes, instead of the moving yoke 7, a pair of moving yokes 7e arranged under the pair of fixed yokes 6e. Each of the pair of moving yokes 7e is formed in the shape of a rectangular parallelepiped. One moving yoke 7e is fixed on the lower surface of the moving contactor 8 so as to be located under the moving contact 81. The other moving yoke 7e is fixed on the lower surface of the moving contactor 8 so as to be located under the moving contact 82. An insulating layer with electrical insulation properties is provided between the pair of moving yokes 7e and the moving contactor 8, thereby ensuring electrical insulation between the pair of moving yokes 7e and the moving contactor 8. The pair of fixed yokes 6e and the pair of moving yokes 7e face each other in the upward/downward direction with the moving contactor 8 interposed between them.

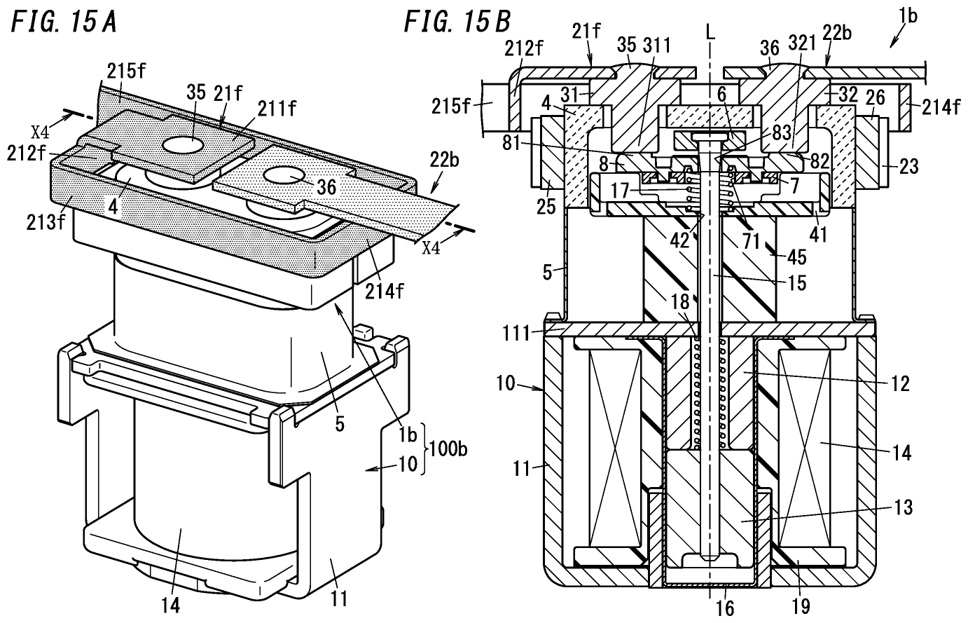

In addition, the bus bar 21b does not have to be arranged with respect to the fixed yoke 6 as described above. Alternatively, the bus bar 21b may be arranged over the fixed yoke 6. For example, the contact device 1b may include the bus bar 21f shown in FIG. 15 instead of the bus bar 21b. The bus bar 21f includes electrical path pieces 211f, 212f, 213f, 214f, and 215f. The bus bar 21f is configured such that the lower end of the electrical path pieces 212f, 213f, 214f, and 215f is located over the fixed yoke 6 when the moving contactor 8 is currently located at the closed position.

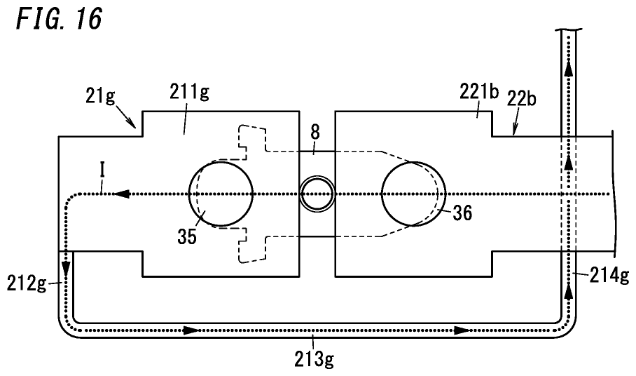

Also, the bus bar 21b is configured such that the electrical path pieces 212b, 213b, 214b, and 215b surround the housing 4 (moving yoke 7) in the embodiment described above. However, this is only an example and should not be construed as limiting. Rather, the bus bar 21b may include at least one pair of electrical path pieces that face each other with the fixed yoke 6 and the moving yoke 7 interposed when viewed from one end in the direction of movement of the moving contactor 8 (i.e., in the upward/downward direction). For example, an alternative bus bar 21g includes electrical path pieces 211g, 212g, 213g, and 214g (see FIG. 16). The bus bar 21g includes every one of the electrical path pieces 211b, 212b, 213b, 214b, and 215b of the bus bar 21b but the electrical path piece 215b, and the electrical path piece 214g extends in the forward/backward direction. In the bus bar 21g, when viewed from one end in the direction of movement of the moving contactor 8 (i.e., in the upward/downward direction), the electrical path pieces 212g (first electrical path piece) and 214g (second electrical path piece) face each other in the rightward/leftward direction with the moving yoke 7 interposed between them.

The electric current I flows through the electrical path pieces 212g and 214g in mutually opposite directions. The direction in which the electric current I flows through the electrical path piece 213g (third electrical path piece) is opposite from the direction in which the electric current I flows through the moving contactor 8.

(Other Variations of Second Embodiment)

Other variations will be enumerated one after another. Any of the variations to be described below may be combined as appropriate with the embodiment described above (including the variations thereof).

In the second embodiment described above, the contact device may include no capsule yokes. When provided, the capsule yokes could weaken the magnetic field applied from the bus bar 21b to the fixed yoke 6 and the moving yoke 7 to possibly cause a decrease in the attractive forces between the fixed yoke 6 and the moving yoke 7. Thus, removing the capsule yokes may increase the attractive forces produced between the fixed yoke 6 and the moving yoke 7, i.e., may increase the force with which the moving contactor 8 is pushed upward.

Also, in the second embodiment described above, the bus bar 21b is configured to, when energized, generate a magnetic field that magnetizes the fixed yoke 6 and the moving yoke 7. However, this is only an example and should not be construed as limiting. Alternatively, the bus bar 22b may also be configured to, when energized, generate a magnetic field that magnetizes the fixed yoke 6 and the moving yoke 7 just as the bus bar 21b does. Still alternatively, both of these bus bars 21b, 22b may be configured to, when energized, generate a magnetic field that magnetizes the fixed yoke 6 and the moving yoke 7.

Furthermore, in the second embodiment described above, the bus bar 21b is electrically connected to the fixed terminal 31. However, this is only an example and should not be construed as limiting. Alternatively, the bus bar is not electrically connected to the fixed terminal 31 but may be configured to generate, when energized, a magnetic field that magnetizes the fixed yoke 6 and the moving yoke 7.

The electromagnetic relay according to the second embodiment is implemented as an electromagnetic relay with no holders. However, this is only an example and should not be construed as limiting. Alternatively, the electromagnetic relay according to the second embodiment may also be implemented as an electromagnetic relay with a holder. In that case, the holder may have the shape of a rectangular cylinder with the right and left end faces open and may be combined with the moving contactor 8 such that the moving contactor 8 runs through the holder in the rightward/leftward direction. The contact pressure spring 17 is arranged between the lower wall of the holder and the moving contactor 8. That is to say, the moving contactor 8 is held by the holder at a central region thereof in the rightward/leftward direction. The upper end of the shaft 15 is secured to the holder. When the excitation coil 14 is energized, the shaft 15 is pushed upward, and therefore, the holder moves upward. This movement causes the moving contactor 8 to move upward, thereby bringing the pair of moving contacts 81, 82 to the closed position where the pair of moving contacts 81, 82 are in contact with the pair of fixed contacts 311, 321, respectively.

(Resume)

A contact device (1) according to a first aspect includes a fixed terminal (31, 32), a moving contactor (8), a moving yoke (7, 7a), and a bus bar (21, 21a). The fixed terminal (31, 32) has a fixed contact (311, 321). The moving contactor (8) has a moving contact (81, 82) and moves from a closed position where the moving contact (81, 82) is in contact with the fixed contact (311, 321) to an open position where the moving contact (81, 82) is out of contact with the fixed contact (311, 321), and vice versa. The moving yoke (7, 7a) moves, as the moving contactor (8) moves, in a direction of movement of the moving contactor (8). The bus bar (21, 21a) generates, when energized, a magnetic field having a direction aligned with the direction of movement of the moving contactor (8). The bus bar (21, 21a) is arranged, with respect to the moving yoke (7, 7a) when the moving contactor (8) is currently located at the closed position, in a direction in which the moving contactor (8) moves from the open position toward the closed position.

This aspect allows the moving yoke (7, 7a) to be magnetized by a magnetic field generated by the bus bar (21, 21a) and also allows the moving yoke (7, 7a) to be attracted toward the bus bar (21, 21a), thus increasing the force with which the moving contactor (8) presses the moving contact (81, 82). This increases the stability of connection between the moving contact (81, 82) and the fixed contact (311, 321).

A contact device (1b) according to a second aspect includes a fixed terminal (31, 32), a moving contactor (8), a moving yoke (7, 7a), a fixed yoke (6, 6c, 6d, 6e), and a bus bar (21b, 21d, 21f, 21g). The fixed terminal (31, 32) has a fixed contact (311, 321). The moving contactor (8) has a moving contact (81, 82) and moves from a closed position where the moving contact (81, 82) is in contact with the fixed contact (311, 321) to an open position where the moving contact (81, 82) is out of contact with the fixed contact (311, 321), and vice versa. The moving yoke (7, 7e) moves, as the moving contactor (8) moves, in a direction of movement of the moving contactor (8). The fixed yoke (6, 6c, 6d, 6e) is arranged on the same side as the fixed contact (311, 321) with respect to the moving yoke (7, 7a) so as to face the moving yoke (7, 7e) in the direction of movement of the moving contactor (8). The fixed yoke (6, 6c, 6d, 6e) has a relative position thereof fixed with respect to the fixed terminal (31, 32) when the moving contactor (8) is currently located at the closed position. The bus bar (21b, 21d, 21f, 21g) generates, when energized, a magnetic field that magnetizes the moving yoke (7, 7e) and the fixed yoke (6, 6c, 6d, 6e) such that respective poles, facing each other, of the moving yoke (7, 7e) and the fixed yoke (6, 6c, 6d, 6e) have mutually opposite polarities.

This aspect causes magnetic attractive forces to be produced between the fixed yoke (6, 6c, 6d, 6e) and the moving yoke (7, 7e) by the magnetic field generated by the bus bar (21b, 21d, 21f, 21g), thus allowing the magnetic attractive forces produced to increase the force with which the moving contactor (8) presses the fixed contact (311, 321). This increases the stability of connection between the moving contact (81, 82) and the fixed contact (311, 321).

In a contact device (1, 1b) according to a third aspect, which may be implemented in conjunction with the first or second aspect, the bus bar (21, 21a, 21b, 21d, 21f, 21g) is electrically connected to the fixed terminal (31, 32).

This aspect allows the bus bar (21, 21a, 21b, 21d, 21f, 21g) to magnetize, using an electric current flowing through itself, the moving yoke (7, 7a, 7e).

In a contact device (1, 1b) according to a fourth aspect, which may be implemented in conjunction with any one of the first to third aspects, the bus bar (21, 21a, 21b, 21d, 21f, 21g) includes: a first electrical path piece (213, 212a, 213b, 213d, 213f, 212g) and a second electrical path piece (215, 214a, 215b, 215d, 215f, 214g) arranged to face each other with the moving yoke (7, 7a, 7e) interposed when viewed from one end in the direction of movement of the moving contactor (8); and a third electrical path piece (214, 213a, 214b, 214d, 214f, 213g) to join the first electrical path piece (213, 212a, 213b, 213d, 213f, 212g) and the second electrical path piece (215, 214a, 215b, 215d, 215f, 214g) together. An electric current flows in two opposite directions through the first electrical path piece (213, 212a, 213b, 213d, 213f, 212g) and the second electrical path piece (215, 214a, 215b, 215d, 215f, 214g), respectively.

This aspect increases the strength of the magnetic field applied from the bus bar (21, 21a, 21b, 21d, 21f, 21g) to the moving yoke (7, 7a, 7e), thus increasing the stability of connection between the moving contact (81, 82) and the fixed contact (311, 321).

In a contact device (1, 1b) according to a fifth aspect, which may be implemented in conjunction with the fourth aspect, when the moving contactor (8) is currently located at the closed position, at least part of the first electrical path piece (213, 212a, 213b, 213d, 213f, 212g) and at least part of the second electrical path piece (215, 214a, 215b, 215d, 215f, 214g) are arranged on the same side as the fixed contact (311, 321) with respect to the moving contactor (8) in the direction of movement of the moving contactor (8).

This aspect allows the bus bar (21, 21a, 21b, 21d, 21f, 21g) to magnetize the moving yoke (7, 7a, 7e).

In a contact device (1, 1b) according to a sixth aspect, which may be implemented in conjunction with the fourth or fifth aspect, directions in which an electric current flows through the first electrical path piece (213, 212a, 213b, 213d, 213f, 212g) and the second electrical path piece (215, 214a, 215b, 215d, 215f, 214g) are aligned with a direction in which an electric current flows through the moving contactor (8).

This aspect allows the bus bar (21, 21a, 21b, 21d, 21f, 21g) to magnetize the moving yoke (7, 7a, 7e).

In a contact device (1, 1b) according to a seventh aspect, which may be implemented in conjunction with the fourth or fifth aspect, a direction in which an electric current flows through the third electrical path piece (213a, 213g) is opposite from a direction in which an electric current flows through the moving contactor (8). When the moving contactor (8) is currently located at the closed position, at least part of the third electrical path piece (213a, 213g) is arranged on the same side as the fixed contact with respect to the moving contactor (8) in the direction of movement of the moving contactor (8).

This aspect allows the bus bar (21, 21a, 21b, 21d, 21f, 21g) to magnetize the moving yoke (7, 7a, 7e).

In a contact device (1) according to an eighth aspect, which may be implemented in conjunction with any one of the first to seventh aspects, the bus bar (21, 21a, 21b, 21d, 21f, 21g) is configured to surround the moving yoke (7, 7a, 7e) when viewed from one end in the direction of movement of the moving contactor (8).

This aspect increases the strength of the magnetic field applied from the bus bar (21, 21a, 21b, 21d, 21f, 21g) to the moving yoke (7, 7a, 7e), thus increasing the magnetic attractive forces that attract the moving yoke (7, 7a, 7e) toward the bus bar (21, 21a, 21b, 21d, 21f, 21g).

A contact device (1, 1b) according to a ninth aspect, which may be implemented in conjunction with any one of the first to eighth aspects, further includes a housing (4) to house at least the fixed contact (311, 321) and the moving contactor (8).

This aspect allows the housing (4) to protect the fixed contact (311, 321) and the moving contactor (8).

In a contact device (1, 1b) according to a tenth aspect, which may be implemented in conjunction with the ninth aspect, the bus bar (21) is arranged outside the housing (4).

This aspect ensures electrical insulation between the bus bar (21, 21a, 21b, 21d, 21f, 21g) and the moving yoke (7, 7a, 7e).

In a contact device (1) according to an eleventh aspect, which may be implemented in conjunction with any one of the first and third to tenth aspects, the moving yoke (7, 7a) is arranged, in the direction of movement of the moving contactor (8), on the same side as the fixed contact (311, 321) with respect to the moving contactor (8).

This aspect allows the moving yoke (7, 7a), magnetized by the magnetic field generated by the bus bar (21, 21a), to be attracted toward the bus bar (21, 21a) and thereby increases the force with which the moving contactor (8) presses the moving contact (81, 82). This increases the stability of connection between the moving contact (81, 82) and the fixed contact (311, 321).

In a contact device (1) according to a twelfth aspect, which may be implemented in conjunction with the sixth aspect, the moving yoke (7a) is relatively movable with respect to the moving contactor (8).

This aspect allows the moving yoke (7a), magnetized by the magnetic field generated by the bus bar (21, 21a), to be attracted toward the bus bar (21, 21a) and thereby increases the force with which the moving contactor (8) presses the moving contact (81, 82). This increases the stability of connection between the moving contact (81, 82) and the fixed contact (311, 321).

In a contact device (1) according to a thirteenth aspect, which may be implemented in conjunction with any one of the first and third to tenth aspects, the moving yoke (7) is arranged, in the direction of movement of the moving contactor (8), on an opposite side from the fixed contact (311, 321) with respect to the moving contactor (8).

This aspect allows the moving yoke (7), magnetized by the magnetic field generated by the bus bar (21, 21a), to be attracted toward the bus bar (21, 21a) and thereby increases the force with which the moving contactor (8) presses the moving contact (81, 82). This increases the stability of connection between the moving contact (81, 82) and the fixed contact (311, 321).

In a contact device (1) according to a fourteenth aspect, which may be implemented in conjunction with the thirteenth aspect, a relative position of the moving yoke (7) with respect to the moving contactor (8) is fixed.

This aspect allows the moving yoke (7), magnetized by the magnetic field generated by the bus bar (21, 21a), to be attracted toward the bus bar (21, 21a) and thereby increases the force with which the moving contactor (8) presses the moving contact (81, 82). This increases the stability of connection between the moving contact (81, 82) and the fixed contact (311, 321).

In a contact device (1b) according to a fifteenth aspect, which may be implemented in conjunction with the second aspect, the bus bar (21b, 21d, 21f, 21g) is configured to surround the fixed yoke (6, 6c, 6d, 6e) when viewed from one end in the direction of movement of the moving contactor (8).

This aspect increases the strength of the magnetic field applied from the bus bar (21b, 21d, 21f, 21g) to the fixed yoke (6, 6c, 6d, 6e) and thereby increases the magnetic attractive forces produced between the fixed yoke (6, 6c, 6d, 6e) and the moving yoke (7, 7e). In the fifteenth aspect, the bus bar (21b, 21d, 21f, 21g) is suitably configured to further surround the moving yoke (7, 7e) when viewed from one end of the direction of movement of the moving contactor (8). This increases the strength of the magnetic field applied from the bus bar (21b, 21d, 21f, 21g) to the fixed yoke (6, 6c, 6d, 6e) and the moving yoke (7, 7e) and thereby increases the magnetic attractive forces produced between the fixed yoke (6, 6c, 6d, 6e) and the moving yoke (7, 7e).

In a contact device (1b) according to a sixteenth aspect, which may be implemented in conjunction with the second or fifteenth aspect, the fixed yoke (6, 6c, 6d, 6e) is located, in the direction of movement of the moving contactor (8), between the bus bar (21b, 21d, 21f, 21g) and the moving yoke (7, 7e).

This aspect causes magnetic attractive forces to be produced between the fixed yoke (6, 6c, 6d, 6e) and the moving yoke (7, 7e) by the magnetic field generated by the bus bar (21b, 21d, 21f, 21g), thus allowing the magnetic attractive forces produced to increase the force with which the moving contactor (8) presses the fixed contact (311, 321). This increases the stability of connection between the moving contact (81, 82) and the fixed contact (311, 321).

In a contact device (1b) according to a seventeenth aspect, which may be implemented in conjunction with any one of the second and fifteenth to seventeenth aspects, the bus bar (21b, 21d, 21f, 21g) is located, in the direction of movement of the moving contactor (8), between the fixed yoke (6, 6c, 6d, 6e) and the moving yoke (7, 7e) when the moving contactor (8) is currently located at the closed position.

This aspect causes magnetic attractive forces to be produced between the fixed yoke (6, 6c, 6d, 6e) and the moving yoke (7, 7e) by the magnetic field generated by the bus bar (21b, 21d, 21f, 21g), thus allowing the magnetic attractive forces produced to increase the force with which the moving contactor (8) presses the fixed contact (311, 321). This increases the stability of connection between the moving contact (81, 82) and the fixed contact (311, 321).

A contact device (1b) according to an eighteenth aspect, which may be implemented in conjunction with any one of the second and fifteenth to seventeenth aspects, further includes a housing (4) to house at least the fixed contact (311, 321) and the moving contactor (8). The bus bar (21b, 21d, 21f, 21g) is arranged outside the housing (4).

This aspect allows the housing (4) to protect the fixed contact (311, 321) and the moving contactor (8). In addition, this aspect also ensures electrical insulation between the bus bar (21b, 21d, 21f, 21g) and the fixed yoke (6, 6c, 6d, 6e) or the moving yoke (7, 7e).

A contact device (1b) according to a nineteenth aspect, which may be implemented in conjunction with any one of the second and fifteenth to seventeenth aspects, further includes a housing (4) to house at least the fixed contact (311, 321) and the moving contactor (8). The fixed yoke (6c, 6d) is provided for the housing (4).

This aspect allows the housing (4) to protect the fixed contact (311, 321) and the moving contactor (8), and also allows the position of the fixed yoke (6c, 6d) to be fixed. In the nineteenth aspect, the bus bar (21b, 21d, 21f, 21g) is suitably arranged outside the housing (4). This aspect also ensures electrical insulation between the bus bar (21b, 21d, 21f, 21g) and the fixed yoke (6, 6c, 6d, 6e) or the moving yoke (7, 7e).

In a contact device (1b) according to a twentieth aspect, which may be implemented in conjunction with any one of the second and fifteenth to seventeenth aspects, the fixed yoke (6e) is provided for the fixed terminal (31, 32).

This aspect allows the magnetic attractive forces produced between the fixed yoke (6e) and the moving yoke (7, 7e) to be efficiently transmitted to the moving contactor (8) and increases the force with which the moving contactor (8) presses the fixed contact (311, 321).

In a contact device (1, 1b) according to a twenty-first aspect, which may be implemented in conjunction with any one of the first to twentieth aspects, the fixed terminal (31, 32) includes a first fixed terminal (31) and a second fixed terminal (32). The fixed contact (311, 321) includes a first fixed contact (311) provided for the first fixed terminal (31) and a second fixed contact (321) provided for the second fixed terminal (32). The moving contact (81, 82) includes a first moving contact (81) and a second moving contact (82) configured to come into contact with the first fixed contact (311) and the second fixed contact (321), respectively, when the moving contactor (8) is currently located at the closed position.

This aspect allows an associated moving contact (81, 82) to be pressed against each fixed contact (311, 321) of the fixed terminal (31, 32).

In a contact device (1, 1b) according to a twenty-second aspect, which may be implemented in conjunction with the twenty-first aspect, the bus bar (21, 21b, 21d, 210 includes a pair of electrical path pieces (213, 215, 213b, 215b, 213d, 215d, 213f, 2150 which are arranged in a direction in which the first fixed contact (311) and the second fixed contact (321) are arranged side by side and through which an electric current flows in two opposite directions.

This aspect allows a magnetic field aligned with the direction of movement of the moving contactor (8) to be generated efficiently.

An electromagnetic relay (100, 100b) according to a twenty-third aspect includes the contact device (1, 1b) according to any one of the first to twenty-second aspects and an electromagnet device (10, 10b) to move the moving contactor (8).

This aspect increases the stability of connection between the moving contact (81, 82) and the fixed contact (311, 321).

Note that the constituent elements according to the third through twenty-second aspects are not essential constituent elements for the contact device (1, 1b) but may be omitted as appropriate.

### REFERENCE SIGNS LIST

| 1, 1b | Contact Device |
|---|---|
| 21, 21a, 21b, 21d, 21f, 21g | Bus Bar |
| 213, 212a, 213b, 213d, | First Electrical Path Piece |
| 213f, 212g | |
| 215, 214a, 215b, 215d, | Second Electrical Path Piece |
| 215f, 214g | |
| 214, 213a, 214b, 214d, | Third Electrical Path Piece |
| 214f, 213g | |
| 31 | Fixed Terminal (First Fixed Terminal) |
| 311 | Fixed Contact (First Fixed Contact) |
| 32 | Fixed Terminal (Second Fixed Terminal) |
| 321 | Fixed Contact (Second Fixed Contact) |
| 4 | Housing |
| 6, 6c, 6d, 6e | Fixed Yoke |
| 7, 7a, 7e | Moving Yoke |
| 8 | Moving Contactor |
| 81 | Moving Contact (First Moving Contact) |
| 82 | Moving Contact (Second Moving Contact) |
| 10, 10b | Electromagnet Device |
| 100 | Electromagnetic Relay |

1. A contact device comprising:
a fixed terminal having a fixed contact;
a moving contactor having a moving contact and configured to move from a closed position where the moving contact is in contact with the fixed contact to an open position where the moving contact is out of contact with the fixed contact, and vice versa;
a moving yoke configured to move, as the moving contactor moves, in a direction of movement of the moving contactor; and
a bus bar configured to generate, when energized, a magnetic field having a direction aligned with the direction of movement of the moving contactor,
the bus bar being arranged, with respect to the moving yoke when the moving contactor is currently located at the closed position, in a direction in which the moving contactor moves from the open position toward the closed position.

2. A contact device comprising:
a fixed terminal having a fixed contact;
a moving contactor having a moving contact and configured to move from a closed position where the moving contact is in contact with the fixed contact to an open position where the moving contact is out of contact with the fixed contact, and vice versa;
a moving yoke configured to move, as the moving contactor moves, in a direction of movement of the moving contactor;
a fixed yoke arranged on the same side as the fixed contact with respect to the moving yoke so as to face the moving yoke in the direction of movement of the moving contactor, the fixed yoke having a relative position thereof fixed with respect to the fixed terminal when the moving contactor is currently located at the closed position; and
a bus bar configured to generate, when energized, a magnetic field that magnetizes the moving yoke and the fixed yoke such that respective poles, facing each other, of the moving yoke and the fixed yoke have mutually opposite polarities.

3. The contact device of claim 1, wherein
the bus bar is electrically connected to the fixed terminal.

4. The contact device of claim 2, wherein
the bus bar includes: a first electrical path piece and a second electrical path piece arranged to face each other with the moving yoke interposed when viewed from one end in the direction of movement of the moving contactor; and a third electrical path piece configured to join the first electrical path piece and the second electrical path piece together, and
an electric current flows in two opposite directions through the first electrical path piece and the second electrical path piece, respectively.

5. The contact device of claim 4, wherein
when the moving contactor is currently located at the closed position, at least part of the first electrical path piece and at least part of the second electrical path piece are arranged on the same side as the fixed contact with respect to the moving contactor in the direction of movement of the moving contactor.

6. The contact device of claim 4 or 5, wherein
directions in which an electric current flows through the first electrical path piece and the second electrical path piece are aligned with a direction in which an electric current flows through the moving contactor.

7. The contact device of claim 4 or 5, wherein
a direction in which an electric current flows through the third electrical path piece is opposite from a direction in which an electric current flows through the moving contactor, and
when the moving contactor is currently located at the closed position, at least part of the third electrical path piece is arranged on the same side as the fixed contact with respect to the moving contactor in the direction of movement of the moving contactor.

8. The contact device of claim 2, wherein
the bus bar is configured to surround the moving yoke when viewed from one end in the direction of movement of the moving contactor.

9. The contact device of claim 2, further comprising a housing configured to house at least the fixed contact and the moving contactor.

10. The contact device of claim 9, wherein
the bus bar is arranged outside the housing.

11.-14. (canceled)

15. The contact device of claim 2, wherein
the bus bar is configured to surround the fixed yoke when viewed from one end in the direction of movement of the moving contactor.

16. The contact device of claim 2, wherein
the fixed yoke is located, in the direction of movement of the moving contactor, between the bus bar and the moving yoke.

17. The contact device of claim 2, wherein
the bus bar is located, in the direction of movement of the moving contactor, between the fixed yoke and the moving yoke when the moving contactor is currently located at the closed position.

18. The contact device of claim 2, further comprising a housing configured to house at least the fixed contact and the moving contactor, wherein
the bus bar is arranged outside the housing.

19. The contact device of claim 2, further comprising a housing configured to house at least the fixed contact and the moving contactor, wherein
the fixed yoke is provided for the housing.

20. The contact device of claim 2, wherein
the fixed yoke is provided for the fixed terminal.

21. The contact device of claim 2, wherein
the fixed terminal includes a first fixed terminal and a second fixed terminal,
the fixed contact includes a first fixed contact provided for the first fixed terminal and a second fixed contact provided for the second fixed terminal, and
the moving contact includes a first moving contact and a second moving contact configured to come into contact with the first fixed contact and the second fixed contact, respectively, when the moving contactor is currently located at the closed position.

22. The contact device of claim 21, wherein
the bus bar includes a pair of electrical path pieces which are arranged in a direction in which the first fixed contact and the second fixed contact are arranged side by side and through which an electric current flows in two opposite directions.

23. An electromagnetic relay comprising:
the contact device of claim 2; and
an electromagnet device configured to move the moving contactor.
